(19) United States
(12) Patent Application Publication
(10) Pub. No.: US 2025/0336328 A1
(43) Pub. Date: Oct. 30, 2025

(54) ELECTRONIC DEVICE AND METHOD FOR DITHERING IMAGE

(71) Applicant: SAMSUNG ELECTRONICS CO., LTD., Suwon-si (KR)

(72) Inventors: Taehyung KIM, Suwon-si (KR); Jaewoong SOH, Suwon-si (KR); IIjun AHN, Suwon-si (KR); Guiwon SEO, Suwon-si (KR)

(73) Assignee: SAMSUNG ELECTRONICS CO., LTD., Suwon-si (KR)

(21) Appl. No.: 19/251,039

(22) Filed: Jun. 26, 2025

Related U.S. Application Data
(63) Continuation of application No. PCT/KR2025/005919, filed on Apr. 30, 2025.

(30) Foreign Application Priority Data
Apr. 30, 2024 (KR) 10-2024-0058162
Dec. 23, 2024 (KR) 10-2024-0194620

(51) Int. Cl. G09G 3/20; G09G 3/34

(52) U.S. Cl. CPC G09G 3/2044; G09G 3/344; G09G 2320/0242; G09G 2320/0276; G09G 2320/0666

(57) ABSTRACT

Provided are an electronic device and method for dithering an image. The method of dithering an image includes obtaining a probability value of at least one pixel of an input image, based on pre-stored weight value data, wherein the probability value of the at least one pixel comprises a probability value for each of a plurality of colors of a color palette of a display; and obtaining a dithered image associated with the input image using sampling based on the probability value of the at least one pixel and uniform distribution noise, wherein the pre-stored weight value data comprises first weight values optimized to represent a plurality of preset colors, and wherein the optimization is based on a weighted sum of the plurality of colors of the color palette.

### CROSS-REFERENCES TO RELATED APPLICATIONS

This application is a continuation of International Application No. PCT/KR2025/005919, filed on Apr. 30, 2025, with the Korean Intellectual Property Office, which claims priority from Korean Patent Application No. 10-2024-0058162, filed on Apr. 30, 2024, with the Korean Intellectual Property Office, and Korean Patent Application No. 10-2024-0194620, filed on Dec. 23, 2024, with the Korean Intellectual Property Office, the entireties of which are incorporated herein by reference.

### FIELD

The disclosure relates to an electronic device and method for dithering an image. In particular, the disclosure relates to an electronic device and method for dithering an image through probability-based sampling based on uniform distribution noise.

### BACKGROUND

In a display using a limited color palette, such as an electronic ink display, image dithering is important for improving visual quality. There is a need for more suitable image dithering techniques to obtain smooth gray scale expression and color reproduction.

### SUMMARY

According to an aspect of the disclosure, a method of dithering an image is disclosed. In an embodiment of the disclosure, the method may include obtaining a probability value of at least one pixel of an input image, based on pre-stored weight value data, wherein the probability value of the at least one pixel comprises a probability value for each of a plurality of colors of a color palette of a display; and obtaining a dithered image associated with the input image using sampling based on the probability value of the at least one pixel and uniform distribution noise, wherein the pre-stored weight value data comprises first weight values optimized to represent a plurality of preset colors, and wherein the optimization is based on a weighted sum of the plurality of colors of the color palette.

In an embodiment of the disclosure, an electronic device for dithering an image is disclosed. In an embodiment of the disclosure, the electronic device may include a display, memory storing one or more instructions, and at least one processor configured to execute the one or more instructions stored in the memory. In an embodiment of the disclosure, the at least one processor may be configured to obtain a probability value of at least one pixel of an input image, based on weight value data pre-stored in the memory (2100), wherein the probability value of the at least one pixel comprises a probability value for each of a plurality of colors of a color palette of the display; and obtain a dithered image associated with the input image using sampling based on the probability value of the at least one pixel and uniform distribution noise, wherein the pre-stored weight value data comprises first weight values optimized to represent a plurality of preset colors, wherein the optimization is based on a weighted sum of the plurality of colors of the color palette.

According to an aspect of the disclosure, a non-transitory computer-readable recording medium having recorded thereon one or more instructions that when executed by one or more processors, causes the one or more processors to obtain a probability value of at least one pixel of an input image, based on weight value data pre-stored in the memory (2100), wherein the probability value of the at least one pixel comprises a probability value for each of a plurality of colors of a color palette of the display; and obtain a dithered image associated with the input image using sampling based on the probability value of the at least one pixel and uniform distribution noise, wherein the pre-stored weight value data comprises first weight values optimized to represent a plurality of preset colors, wherein the optimization is based on a weighted sum of the plurality of colors of the color palette.

### BRIEF DESCRIPTION OF DRAWINGS

FIG. 1 is a diagram illustrating operations of an electronic device according to an embodiment of the disclosure.

FIG. 2 is a flowchart of a process performed by an electronic device to render an image, according to an embodiment of the disclosure.

FIG. 3 is a diagram illustrating a process performed by an electronic device to dither an image, according to an embodiment of the disclosure.

FIG. 4 is a diagram illustrating a process performed by an electronic device to preprocess an image, according to an embodiment of the disclosure.

FIG. 5 is a diagram illustrating a process performed by an electronic device to optimize a probability map, according to an embodiment of the disclosure.

FIGS. 6A and 6B are diagrams illustrating processes performed by an electronic device to obtain optimized weight values from pre-stored weight value data, according to an embodiment of the disclosure.

FIG. 7 is a diagram illustrating a process performed by an electronic device to perform probability correction, according to an embodiment of the disclosure.

FIG. 8 is a diagram illustrating a process performed by an electronic device to obtain uniform distribution noise, according to an embodiment of the disclosure.

FIG. 9 is a diagram illustrating a process performed by an electronic device to perform sampling, according to an embodiment of the disclosure.

FIG. 10 is a diagram illustrating a process performed by an electronic device to dither an image based on error diffusion, according to an embodiment of the disclosure.

FIG. 11 is a detailed configuration diagram of an electronic device according to an embodiment of the disclosure.

### DETAILED DISCLOSURE

As for the terms as used in embodiments of the disclosure, common terms that are currently widely used are selected as much as possible while taking into account the functions of the disclosure. However, the terms may vary depending on the intention of those of ordinary skill in the art, precedents, the emergence of new technology, and the like. Also, in a specific case, there are also terms arbitrarily selected by the applicant. In this case, the meaning of the terms will be described in detail in the description of embodiments of the disclosure. Therefore, the terms as used herein should be defined based on the meaning of the terms and the description throughout the disclosure rather than simply the names of the terms.

It will be understood that the singular forms “a,” “an,” and “the” as used herein include the plural forms as well unless the context clearly indicates otherwise. Therefore, for example, the term “configuration surface” may also include a case that indicates one or more of such surfaces.

All terms including technical or scientific terms as used herein have the same meaning as commonly understood by those of ordinary skill in the art.

When one element is referred to as being “connected” or “coupled” to another element, the one element may be directly connected or coupled to the other element, but it will be understood that the elements may be connected or coupled to each other via an intervening element therebetween unless otherwise stated.

Throughout the disclosure, the term “or” is inclusive and not exclusive unless otherwise stated. Therefore, the expression “A or B” may indicate “A,” “B,” or “both A and B” unless the context clearly indicates otherwise. Throughout the disclosure, the expression “at least one of” or “one or more of” refer to a case where different combinations of one or more of the listed items are used or a case where only one of the listed items is required. For example, the expression “at least one of A, B, and C” may include only A, only B, only C, A and B, A and C, B and C, or all of A, B, and C.

Throughout the disclosure, the expression “a portion includes a certain element” means that a portion further includes other elements rather than excludes other elements unless otherwise stated. Also, the terms such as “unit” and “module” described in the specification mean units that process at least one function or operation, and may be implemented as hardware, software, or a combination of hardware and software.

The expression “configured to” as used herein may be used interchangeably with, for example, “suitable for,” “having the capacity to,” “designed to,” “adapted to,” “made to,” or “capable of” depending on a situation. The term “configured to” may not necessarily mean only “specifically designed to” in hardware. Alternatively, in some situations, the expression “a system configured to” mean that the system is “capable of . . . ” with other devices or components. For example, “a processor configured to perform A, B, and C” may refer to a dedicated processor (e.g., an embedded processor) for performing corresponding operations or a generic-purpose processor (e.g., a central processing unit (CPU) or an application processor (AP)) capable of performing corresponding operations by executing one or more software programs stored in memory.

In the disclosure, a processor is configured to control a series of processes so that an electronic device operates according to the following embodiment of the disclosure, and may be implemented as one or more processors. The one or more processors included in the processor may be circuitry, such as a system on chip (SoC) or an integrated circuit (IC). The one or more processors included in the processor may be a generic-purpose processor, such as a CPU, a microprocessor unit (MPU), an AP, or a digital signal processor (DSP), a dedicated graphics processor, such as a graphics processing unit (GPU) or a vision processing unit (VPU), a dedicated artificial intelligence processor, such as a neural processing unit (NPU), or a dedicated communication processor, such as a communication processor (CP). For example, when the one or more processors included in the processor are a dedicated artificial intelligence processor, the dedicated artificial intelligence processor may be designed with a hardware structure specialized for processing a specific artificial intelligence model.

In the disclosure, the processor may include various processing circuitries and/or a plurality of processors. For example, the term “processor” as used herein, including the claims, may include various processing circuitries including at least one processor. One or more processors in the at least one processor may be configured to individually and/or collectively perform various functions described herein in a distributed manner. As used herein, the “processor,” “at least one processor,” and “one or more processors” may be configured to perform various functions. However, these terms may cover, without limitation, a situation where one processor performs some functions and other processor(s) perform other functions, and a situation where a single processor may perform all the functions. In addition, the at least one processor may include a combination of processors that perform the disclosed various functions in a distributed manner. The at least one processor may execute program instructions to accomplish or perform various functions.

The processor may write data to memory or read data stored in memory. In particular, the processor may execute at least one instruction or a program stored in memory to process data in accordance with predefined operation rules or artificial intelligence models. Accordingly, the processor may perform operations described in the following embodiment of the disclosure. In the following embodiment of the disclosure, operations described as being performed by an electronic device or detailed components included in the electronic device may be understood as being performed by the processor unless otherwise stated.

It will be understood that the blocks in the flowcharts and combinations of the flowcharts in the disclosure may be performed by one or more computer programs including computer-executable instructions. The one or more computer programs may be stored in a single memory, or may be segmented and stored in a plurality of different memories.

All functions or operations described in the disclosure may be processed by a single processor or a combination of processors. The single processor or the combination of processors is circuitry that performs processing and may include circuitry, such as an AP, a CP, a GPU, an NPU, an MPU, a SoC, or an integrated chip (IC).

It will be understood that the respective blocks of flowcharts and combinations of the flowcharts may be performed by computer program instructions. Because these computer program instructions may be embedded in a processor of a generic-purpose computer, a special-purpose computer, or other programmable data processing apparatuses, the instructions to be executed through the processor of the computer or other programmable data processing apparatus generate modules for performing the functions described in the flowchart block(s). Because these computer program instructions may also be stored in a computer-executable or computer-readable memory that may direct the computer or other programmable data processing apparatus so as to implement functions in a particular manner, the instructions stored in the computer-executable or computer-readable memory are also capable of producing an article of manufacture containing instruction modules for performing the functions described in the flowchart block(s). Because the computer program instructions may also be embedded in the computer or other programmable data processing apparatus, the instructions for executing the computer or other programmable data processing apparatuses by generating a computer-implemented process by performing a series of operations on the computer or other programmable data processing apparatuses may provide operations for executing the functions described in the flowchart block(s).

Also, each block may represent part of a module, segment, or code that includes one or more executable instructions for executing a specified logical function(s). It should also be noted that, in some alternative implementations, the functions described in the blocks may occur out of the order noted in the drawings. For example, two blocks illustrated in succession may in fact be executed substantially concurrently, or the blocks may sometimes be executed in a reverse order, depending on the functions involved therein.

In the disclosure, the term “dithering” may refer to an image processing method of softening boundaries between values by adding artificial noise so as to improve visual quality in a limited expression range. In an embodiment of the disclosure, dithering may be used to visually express a wider color spectrum within a limited color range of a color palette, to implement a continuous brightness change or contrast, or to soften boundaries between colors or contrast.

In the disclosure, the term “color palette” may refer to a set of limited colors that may be used on a particular display or may be expressed on a particular display. In an embodiment of the disclosure, a plurality of pixels of a display may be displayed as one of a plurality of colors of a color palette.

In the disclosure, the term “probability map” may refer to a map indicating a probability that a specific event or a specific state will occur at each point in a space. In an embodiment of the disclosure, a probability map of an image may include a probability map for colors, which includes a probability that each of a plurality of pixels of an image will represent a specific color. In an embodiment of the disclosure, the probability map may include a plurality of channels respectively corresponding to a plurality of colors. The plurality of channels may respectively include probability values for the plurality of colors.

In the disclosure, the term “uniform distribution noise” may refer to noise in which all values have the same probability density within a given range. In an embodiment of the disclosure, the uniform distribution noise is noise in which values are randomly generated within a given range, and all values may be generated with equal probability within a given range.

In the disclosure, the term “sampling” may refer to an operation of extracting (or selecting) or generating some pieces of data reflecting characteristics of a specific distribution or set. In an embodiment of the disclosure, sampling may include an operation of extracting or generating data that follows a particular probability distribution. In an embodiment of the disclosure, sampling may include inverse transform sampling based on a cumulative distribution function (CDF).

Hereinafter, an embodiment of the disclosure will be described in detail with reference to the accompanying drawings, so that those of ordinary skill in the art may easily carry out the disclosure. However, the disclosure may be implemented in various different forms and is not limited to the embodiment of the disclosure described herein. In order to clearly explain the disclosure, parts irrelevant to the description are omitted in the drawings, and similar reference numerals are assigned to similar parts throughout the specification.

Hereinafter, the disclosure is described with reference to the accompanying drawings.

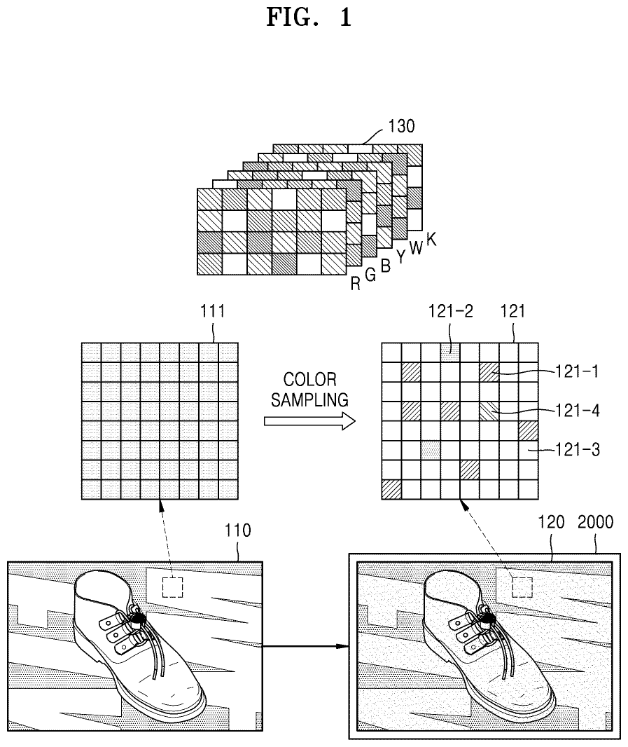

FIG. 1 is a diagram schematically illustrating operations of an electronic device 2000 according to an embodiment of the disclosure.

In an embodiment of the disclosure, the electronic device 2000 may display a dithered image 120 corresponding to an input image 110. The dithered image 120 may be an image in which the input image 110 is expressed in a plurality of colors of a color palette of a display. In other words, the dithered image 120 may have the same size as the size of the input image 110, and a plurality of pixels of the dithered image 120 may have a corresponding relationship with a plurality of pixels of the input image 110. For example, the display of the electronic device 2000 may be a display that uses (or expresses) only a plurality of colors of a color palette consisting of red, green, blue, yellow, white, and black. On the other hand, a plurality of pixels of a region 111 of the input image 110 may include pink pixels. In this case, a plurality of pixels of a region 121 of the dithered image 120 corresponding to the region 111 of the input image 110 may include a red pixel 121-1, a yellow pixel 121-2, a green pixel 121-3, and a white pixel 121-4. The plurality of pixels of the region 121 of the dithered image 120 may be combined and mixed in an adjacent space and may be visually recognized by a user. Accordingly, the user may perceive that the color of the region 121 of the dithered image 120 is pink as a whole.

When the input image 110 is expressed in a plurality of colors of a color palette, based on quantization that selects specific colors of a color palette that are closest to the colors of the plurality of pixels of the input image 110, it is difficult to express accurate colors corresponding to the actual colors of the input image 110. In addition, a banding artifact may occur. That is, a region in which the color or brightness of the input image 110 gradually changes appears as stairs or bands.

In an embodiment of the disclosure, the electronic device 2000 may obtain the dithered image 120 based on a probability map 130 of the input image 110. In an embodiment of the disclosure, the probability map 130 may include a plurality of channels respectively corresponding to the plurality of colors of the color palette. For example, the probability map 130 may include red, green, blue, yellow, white, and black channels, which are the plurality of colors of the color palette. The plurality of channels of the probability map 130 may include probability values for the colors corresponding to the respective channels. In an embodiment of the disclosure, the electronic device 2000 may determine the colors of the plurality of pixels of the dithered image 120 by performing sampling to select one of the plurality of colors of the color palette based on the probability map 130.

As such, the electronic device 2000 according to an embodiment of the disclosure may render the dithered image 120 through dithering based on the probability map 130. Due to this, when expressing the input image 110 in the plurality of colors of the color palette, the electronic device 2000 may accurately express the colors of the input image 110 and improve a banding artifact, compared to simply selecting colors based on quantization. In addition, because pixel-by-pixel sampling based on probability is performed, the entire input image 110 may be processed in parallel, and thus, fast image dithering may be performed.

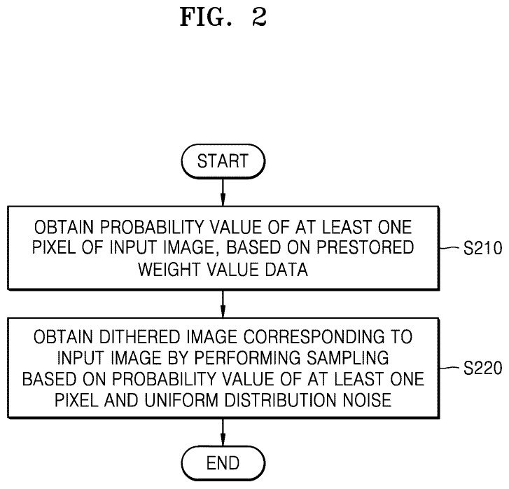

FIG. 2 is a flowchart of an operation performed by the electronic device 2000 to render an image, according to an embodiment of the disclosure.

Referring to FIG. 2, operations performed by the electronic device 2000 to dither an image are briefly described, and a detailed description of the respective operation is given with reference to subsequent drawings.

In operation S210, the electronic device 2000 may obtain a probability value of at least one pixel of an input image, based on pre-stored weight value data. In an embodiment of the disclosure, the probability value of the at least one pixel may include probability values for a plurality of colors of a color palette of a display.

In an embodiment of the disclosure, the pre-stored weight value data may include weight values optimized to express a plurality of preset colors by performing a weighted sum operation on the plurality of colors of the color palette. The weight values optimized to express the plurality of preset colors may include weight values respectively applied to the plurality of colors of the color palette so as to express the plurality of preset colors. For convenience of explanation, the weight values may be referred to as optimized weight values for the plurality of preset colors.

In an embodiment of the disclosure, the sum of the optimized weight values for the plurality of preset colors may be 1. In other words, the sum of the weight values respectively applied to the plurality of colors of the color palette so as to express a specific color may be 1. For example, when one of the plurality of preset colors is a color having a color value (e.g., an RGB value) of (249, 142, 128) and the plurality of colors of the color palette are black, blue, green, red, yellow, and white, the optimized weight values for the color having the color value of (249, 142, 128) may be “0.007,” “0.008,” “0.007,” “0.428,” “0.054,” and “0.496” according to the order of the plurality of colors of the color palette. In this case, the weighted sum obtained by applying the optimized weight values to the color values of the plurality of colors of the color palette may be close to the color value (249, 142, 128).

In an embodiment of the disclosure, the electronic device 2000 may optimize the weight values for the plurality of preset colors. The optimizing of the weight values for the plurality of preset colors may include obtaining weight values applied to the plurality of colors of the color palette that express colors closest to the plurality of preset colors when the weighted sum operation is performed on the plurality of colors of the color palette. For example, when one of the plurality of preset colors is a color having a color value of (249, 142, 128), the optimizing of the weight values for the corresponding color may mean obtaining weight values in which the color value is closest to (249, 142, 128) when the weighted sum operation is performed by applying to the respective color values of black, blue, green, red, yellow, and white, which are the plurality of colors of the color palette.

In an embodiment of the disclosure, the electronic device 2000 may optimize the weight values for the plurality of preset colors based on a difference between the plurality of preset colors and the weighted-sum color obtained by performing the weighted sum operation on the plurality of colors of the color palette and pre-optimization weight values. The difference between the plurality of preset colors and the weighted-sum color may optimize the weight values for the plurality of preset colors based on minimum squared error (MSE) loss between the color values of the plurality of preset colors and the color value of the weighted-sum color. In an embodiment of the disclosure, the electronic device 2000 may obtain weight values, which minimize MSE loss between a color value of a specific color among the plurality of preset colors and the color value of the weighted-sum color, as optimized weight values for the specific color. In an embodiment of the disclosure, the optimized weight values may be respectively mapped or associated with the plurality of preset colors and stored in the memory of the electronic device 2000 as weight value data. In an embodiment of the disclosure, the weight values for the plurality of preset colors may be optimized in an external electronic device. In this case, the electronic device 2000 may receive, from the external electronic device, weight value data including optimized weight values and store the received weight value data in memory.

In an embodiment of the disclosure, the plurality of preset colors may include true colors, which are a combination of all colors expressible in a 24-bit color mode. However, the disclosure is not necessarily limited to the example described above, and the plurality of preset colors may include a combination of fewer colors than the true colors. For example, the plurality of preset colors may include colors of a limited color space where the values of respective RGB channels are spaced apart from each other by 4.

In an embodiment of the disclosure, the electronic device 2000 may obtain weight values optimized to express the colors of the plurality of pixels of the input image by performing the weighted sum operation on the plurality of colors of the color palette based on the pre-stored weight value data. In an embodiment of the disclosure, the optimized weight values may include weight values for the plurality of colors of the color palette. Weight values optimized to express a color of a specific pixel may be referred to as a weight value of the specific pixel or a weight value for the color of the specific pixel. For example, when the color value of the specific pixel of the input image is (156, 244, 128), the electronic device 2000 may obtain optimized weight values for a color having a color value of (156, 244, 128) from the pre-stored weight value data as weight values optimized to express the color of the corresponding pixel. In other words, the electronic device 2000 may obtain optimized weight values for the same colors as the colors of the plurality of pixels of the input image from the pre-stored weight value data as weight values optimized to express the colors of the plurality of pixels of the input image.

In an embodiment of the disclosure, the electronic device 2000 may obtain a probability map of the input image that includes the obtained optimized weight values as probability values of the plurality of pixels. In an embodiment of the disclosure, the probability map may include a plurality of channels respectively corresponding to the plurality of colors of the color palette. In an embodiment of the disclosure, the probability map may have the same size as the size of the input image, and the plurality of pixels of the probability map may have a corresponding relationship with the plurality of pixels of the input image. Accordingly, the probability value of the specific pixel of the probability map may be the probability value of the corresponding pixel of the input image. For example, when the weight values optimized to express the color of the specific pixel of the input image are obtained as “0.012,” “0.024,” “0.351,” “0.005,” “0.126,” and “0.481” in the order of black, blue, green, red, yellow, and white, which are the plurality of colors of the color palette, the probability values of a “black” channel, a “blue” channel, a “green” channel, a “red” channel, a “yellow” channel, and a “white” channel of the corresponding pixel in the probability map may be determined as “0.012,” “0.024,” “0.351,” “0.005,” “0.126,” and “0.481.” In an embodiment of the disclosure, the probability map may be used by the electronic device 2000 to perform sampling on the plurality of pixels of the input image, as described below. That is, the electronic device 2000 may perform parallel processing on a process of determining the colors of all the plurality of pixels of the dithered image by performing sampling based on the probability map including the probability values of the plurality of pixels of the input image. Therefore, the processes performed based on the probability values of the pixels of the image, as described below, may be understood as processes performed based on the probability values of the pixels of the probability map corresponding to the pixels of the image.

In an embodiment of the disclosure, the electronic device 2000 may identify a plurality of colors that are closest to a color of a first pixel of the input image among the plurality of preset colors. In an embodiment of the disclosure, the electronic device 2000 may interpolate optimized weight values to express the color of the first pixel based on the optimized weight values for expressing the plurality of identified colors. For example, the plurality of preset colors may include fewer colors than the true colors, and the color of the first pixel, which is one of the plurality of pixels of the input image, may be colors that are not included in the plurality of preset colors. In this case, the electronic device 2000 may identify eight colors that are closest to the color of the corresponding pixel among the plurality of preset colors. The electronic device 2000 may obtain weight values optimized to express the color of the first pixel by performing trilinear interpolation based on the eight colors. However, the number of the plurality of colors to be identified and the interpolation method corresponding to the number of the plurality of colors to be identified are not necessarily limited to the examples described above, and various interpolation methods may be utilized depending on the number of the plurality of colors to be identified.

In an embodiment of the disclosure, the electronic device 2000 may optimize the weight values for the colors of the plurality of pixels of the input image based on the input image. The optimizing of the weight values for the colors of the plurality of pixels may include obtaining weight values optimized to express colors closest to the colors of the plurality of pixels when the weighted sum operation is performed on the plurality of colors of the color palette. In an embodiment of the disclosure, the electronic device 2000 may determine the optimized weight values for the colors of the plurality of pixels as the probability values of the plurality of pixels. In an embodiment of the disclosure, the electronic device 2000 may obtain a probability map of the input image that includes the optimized weight values as the probability values of the plurality of pixels. In other words, the electronic device 2000 may obtain the probability values of the plurality of pixels of the input image by directly optimizing weight values for the input image without obtaining optimized weight values from the pre-stored weight value data (when the weight value data is not pre-stored, etc.). The optimizing of the weight values for the colors of the plurality of pixels of the input image may be understood as optimizing the probability map that includes the optimized weight values as the probability values of the plurality of pixels.

In an embodiment of the disclosure, the electronic device 2000 may obtain the weighted-sum image by performing the weighted sum operation on the plurality of colors of the color palette and pre-optimization weight values (or probability values of the pre-optimization probability map) corresponding to the plurality of pixels of the input image. In an embodiment of the disclosure, the electronic device 2000 may optimize the weight values for the colors of the plurality of pixels of the input image based on the difference between the input image and the weighted-sum image. The difference between the input image and the weighted-sum image may include MSE loss between the color values of the plurality of pixels of the input image and the color values of the plurality of pixels of the weighted-sum image. In an embodiment of the disclosure, the electronic device 2000 may obtain weight values, which minimize MSE loss between the color value of the specific pixel of the input image and the color value of the specific pixel of the weighted-sum image, as optimized weight values for the color of the specific pixel.

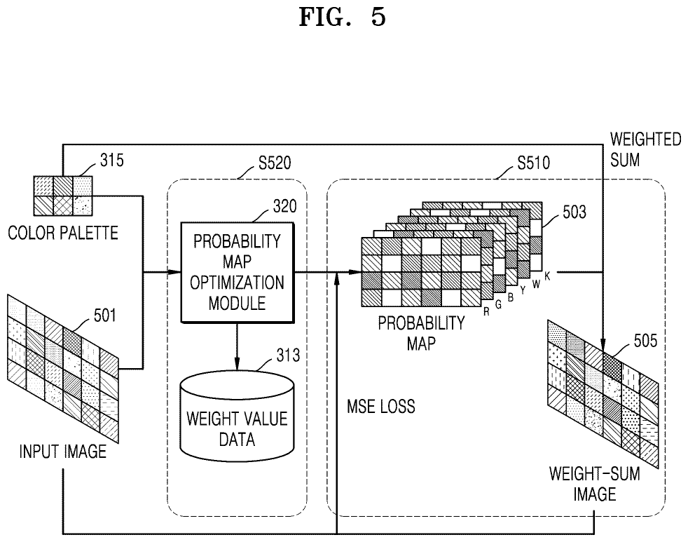

A specific operation of the method, performed by the electronic device 2000, of obtaining the probability map is described again with reference to FIG. 5.

In an embodiment of the disclosure, the electronic device 2000 may perform preprocessing, including at least one of gamma correction or color gamut compression, on the input image.

In an embodiment of the disclosure, the gamma correction may refer to a process of adjusting brightness by applying non-linear transform to pixel values. In an embodiment of the disclosure, the electronic device 2000 may perform gamma correction on the input image based on the plurality of colors of the color palette. For example, as the average brightness of the plurality of colors of the color palette decreases, the electronic device 2000 may increase the gamma value of the gamma correction. As another example, as the number of colors whose brightness is less than or equal to a threshold value among the plurality of colors of the color palette increases, the electronic device 2000 may increase the gamma value of the gamma correction. However, the disclosure is not necessarily limited to the example described above, and the electronic device 2000 may perform preprocessing to adjust the gamma value of the gamma correction in various ways, based on the plurality of colors of the color palette.

In an embodiment of the disclosure, the color gamut compression may refer to a process in which the electronic device 2000 reduces the range of color information of the plurality of pixels of the input image in a color space in which brightness and color information are separated from each other. In an embodiment of the disclosure, the electronic device 2000 may perform gamut compression on the input image based on the plurality of colors of the color palette. For example, the electronic device 2000 may perform color gamut compression so that a color gamut of the plurality of pixels of the input image in a YCbCr color space is included in a color gamut of the plurality of colors of the color palette. The color gamut of the plurality of pixels and the color gamut of the plurality of colors of the color palette may refer to a color gamut formed by a Cb value and a Cr value in the YCbCr color space. However, the disclosure is not necessarily limited to the example described above, and the electronic device 2000 may perform color gamut compression on the input image in various color spaces in various ways.

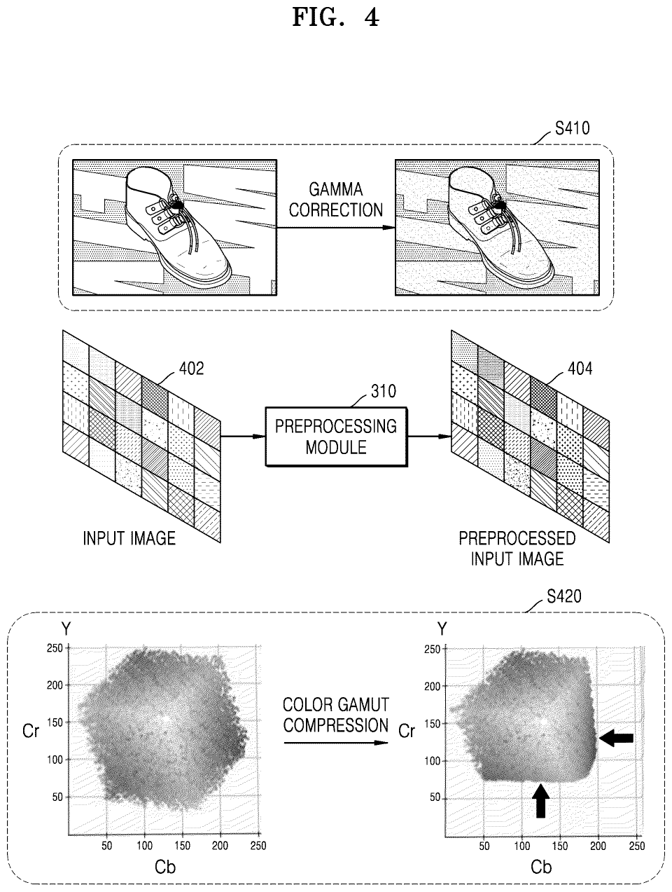

A specific operation of the operation performed by the electronic device 2000 to perform preprocessing on the input image is described again with reference to FIG. 4.

In an embodiment of the disclosure, the electronic device 2000 may perform at least one of first probability correction that adjusts a probability value less than or equal to a threshold value to zero for a probability value of at least one pixel or second probability correction that is temperature scaling for the probability value. The expression “the electronic device 2000 performs probability correction on the probability values of the pixels of the input image may be understood as performing probability correction on the probability values of the probability map of the input image.

In an embodiment of the disclosure, the electronic device 2000 may adjust, to zero, the probability value of the pixel having a probability value less than or equal to the threshold value among the plurality of pixels of the probability map. In an embodiment of the disclosure, the electronic device 2000 may redistribute the reduced probability value of the pixel, the probability value of which has been adjusted, so as to be proportional to the probability values of other channels of the pixel, the probability value of which has been adjusted. In other words, the electronic device 2000 may redistribute the reduced probability value to the probability values of other channels, except for the reduced channel, so that the sum of the probability values of all channels of the pixel, the probability value of which has been adjusted to zero, remains 1. In this case, a ratio at which the probability values are redistributed may be determined based on a ratio between the probability values of other channels.

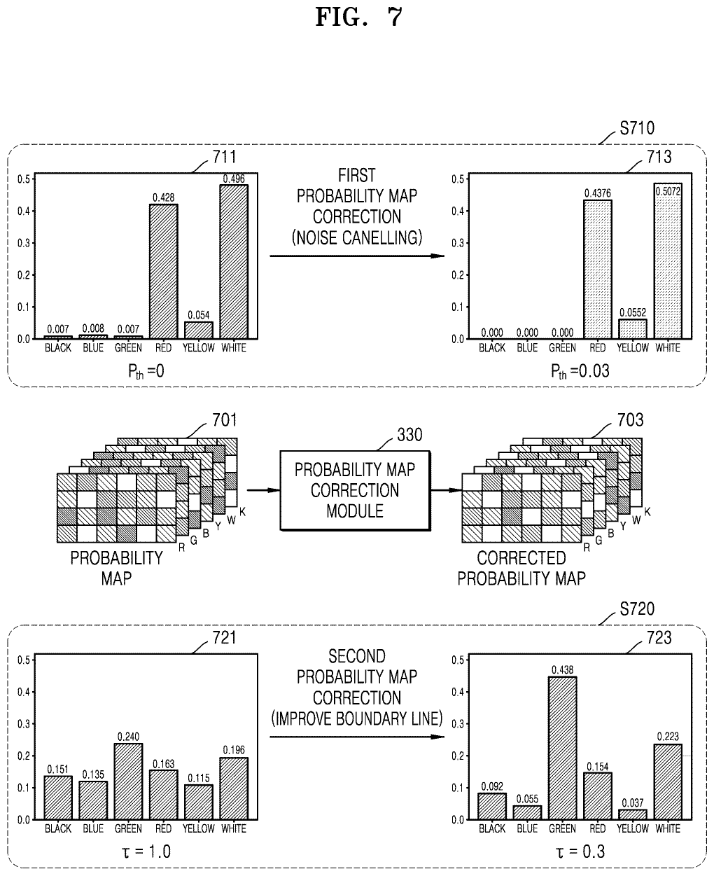

In an embodiment of the disclosure, the electronic device 2000 may perform temperature scaling on the probability values of the plurality of pixels based on gradient magnitudes of the plurality of pixels of the input image. In an embodiment of the disclosure, the electronic device 2000 may calculate the gradient magnitudes of the plurality of pixels of the input image. In an embodiment of the disclosure, the electronic device 2000 may determine temperature parameters of the temperature scaling for the plurality of pixels of the input image based on the calculated gradient magnitudes. The temperature scaling may include probability correction that adjusts a concentration or a confidence level of a probability distribution according to the probability values of the plurality of channels of the probability map, and the temperature scaling may be referred to as temperature adjustment as necessary. In an embodiment of the disclosure, the temperature scaling is performed on the probability values so that channels with high probability values may be adjusted to higher probability values and channels with low probability values may be adjusted to lower probability values. A specific operation performed by the electronic device 2000 to perform probability correction is described again with reference to FIG. 7.

In operation S220, the electronic device 2000 may obtain a dithered image corresponding to the input image by performing sampling based on the probability value of at least one pixel and uniform distribution noise.

In an embodiment of the disclosure, the uniform distribution noise may include blue noise. In an embodiment of the disclosure, the blue noise may include noise values that form a uniform distribution and may have noise characteristics that include many high frequency components and few low frequency components. In an embodiment of the disclosure, the electronic device 2000 may obtain (or extract) blue noise. For example, the electronic device 2000 may obtain blue noise through a void-and-cluster algorithm. However, the disclosure is not necessarily limited to the example described above, and the electronic device 2000 may obtain blue noise through various methods and algorithms, such as Poisson disk sampling or white noise filtering.

In an embodiment of the disclosure, the electronic device 2000 may obtain uniform distribution noise based on at least one pre-stored noise sample. In an embodiment of the disclosure, the at least one pre-stored noise sample may be uniform distribution noise and may include a plurality of noises having different frequency characteristics. The “different frequency characteristics” may mean that noise values have different ratios of frequency components in a frequency response. For example, a plurality of noise samples having different frequency characteristics may include a plurality of blue noises extracted with different density adjustment parameters. In an embodiment of the disclosure, the electronic device 2000 may obtain a plurality of noise samples by applying different density adjustment parameters and may store the plurality of obtained noise samples in the memory. For example, the electronic device 2000 may obtain a plurality of blue noises having different frequency characteristics by changing a sigma value, which is a density adjustment parameter of a void-and-cluster algorithm, and may store the plurality of obtained blue noises in the memory of the electronic device 2000 as at least one noise sample. However, the disclosure is not necessarily limited to the example described above, and at least one noise sample may be obtained from an external electronic device. In this case, the electronic device 2000 may receive the at least one noise sample from the external electronic device and store the received at least one noise sample in the memory.

In an embodiment of the disclosure, the electronic device 2000 may obtain uniform distribution noise corresponding to the input image. The uniform distribution noise corresponding to the input image may be noise having the same size as the size of the input image (or the probability map). In an embodiment of the disclosure, the uniform distribution noise may be noise in which noise values respectively corresponding to the plurality of pixels of the input image (or the probability map) follow a uniform distribution. In an embodiment of the disclosure, the electronic device 2000 may obtain the uniform distribution noise corresponding to the input image by determining the noise value obtained from at least one noise sample pre-stored in the memory as the noise values respectively corresponding to the plurality of pixels of the input image.

In an embodiment of the disclosure, the uniform distribution noise may include noise having a first frequency characteristic corresponding to an object area of the input image and noise having a second frequency characteristic corresponding to the remaining area of the input image excluding the object area. In an embodiment of the disclosure, the second frequency characteristic may have fewer high frequency components and more low frequency components in the frequency response than the first frequency characteristic.

In an embodiment of the disclosure, the electronic device 2000 may identify the object area, which is an area occupied by the object in the input image, and the remaining area excluding the object area. In an embodiment of the disclosure, the electronic device 2000 may obtain a first noise sample and a second noise sample among the plurality of noise samples. In an embodiment of the disclosure, the second noise sample may have fewer high frequency components and more low frequency components in the frequency response than the first noise sample. In an embodiment of the disclosure, the electronic device 2000 may determine, as noise values of the first noise sample, noise values of an area corresponding to the object area of the input image in the uniform distribution noise corresponding to the input image, and may determine, as noise values of the second noise sample, noise values of an area corresponding to the remaining area excluding the object area of the input image.

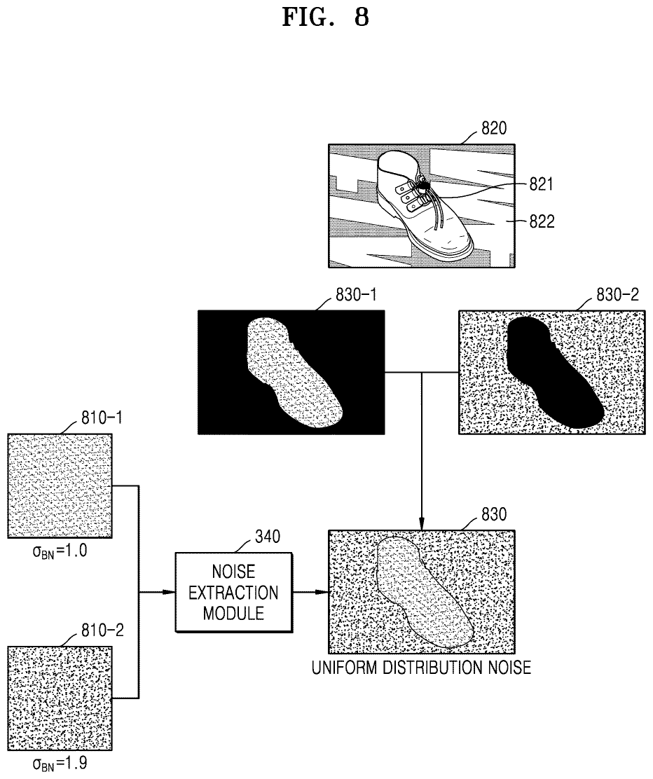

A specific method, performed by the electronic device 2000, of obtaining the uniform distribution noise is described again below with reference to FIG. 8.

In an embodiment of the disclosure, the electronic device 2000 may obtain a cumulative distribution function for a plurality of colors of a color palette of at least one pixel, based on the probability value of at least one pixel. In an embodiment of the disclosure, the cumulative distribution function may refer to a function of accumulating individual probability values for the plurality of colors of the color palette and calculating a total probability for the plurality of colors.

In an embodiment of the disclosure, the electronic device 2000 may sequentially accumulate the probability values of the plurality of pixels of the probability map in a preset order and may calculate cumulative probability values for the plurality of colors of the color palette in the plurality of pixels of the input image. In an embodiment of the disclosure, the electronic device 2000 may obtain the cumulative distribution function for the plurality of colors of the color palette, based on the calculated cumulative probability values. In other words, the electronic device 2000 may obtain a cumulative distribution function of a specific pixel of the input image, based on probability values of a plurality of channels of the specific pixel of the probability map.

In an embodiment of the disclosure, the cumulative distribution function may form a probability distribution in which the plurality of colors of the color palette are accumulated in descending order of correlation with brightness. In an embodiment of the disclosure, the electronic device 2000 may calculate brightness values of the plurality of colors in the color palette, based on the color values of the plurality of colors of the color palette. In an embodiment of the disclosure, the electronic device 2000 may determine one of the plurality of colors of the color palette as a reference color. In an embodiment of the disclosure, the electronic device 2000 may sequentially accumulate the plurality of colors of the color palette in ascending order of the difference from the brightness value of the reference color and may calculate the cumulative probability values for the plurality of colors of the color palette. For example, when the plurality of colors of the color palette are black, blue, green, red, yellow, and white and white is determined as the reference color, the cumulative distribution function may form a cumulative probability distribution in which the plurality of colors are accumulated in the ascending order of the difference from the brightness value of white, that is in the order of white, yellow, green, red, blue, and black.

In an embodiment of the disclosure, the electronic device 2000 may determine the color of at least one pixel of the dithered image corresponding to the at least one pixel as one of the plurality of colors of the color palette by performing inverse transform sampling based on the value of the uniform distribution noise and the cumulative distribution function.

In an embodiment of the disclosure, the electronic device 2000 may perform inverse transform sampling on the plurality of pixels of the probability map by applying the values of the uniform distribution noise corresponding to the plurality of pixels of the probability map to an inverse function of the cumulative distribution function of the plurality of pixels of the probability map as random numbers for the inverse transform sampling. In an embodiment of the disclosure, one of the plurality of colors of the color palette may be selected for the plurality of pixels of the probability map as a result of the inverse transform sampling. In an embodiment of the disclosure, the electronic device 2000 may obtain the dithered image corresponding to the image by determining the colors, which are selected as a result of the inverse transform sampling, as the colors of the plurality of pixels of the dithered image corresponding to the plurality of pixels of the probability map.

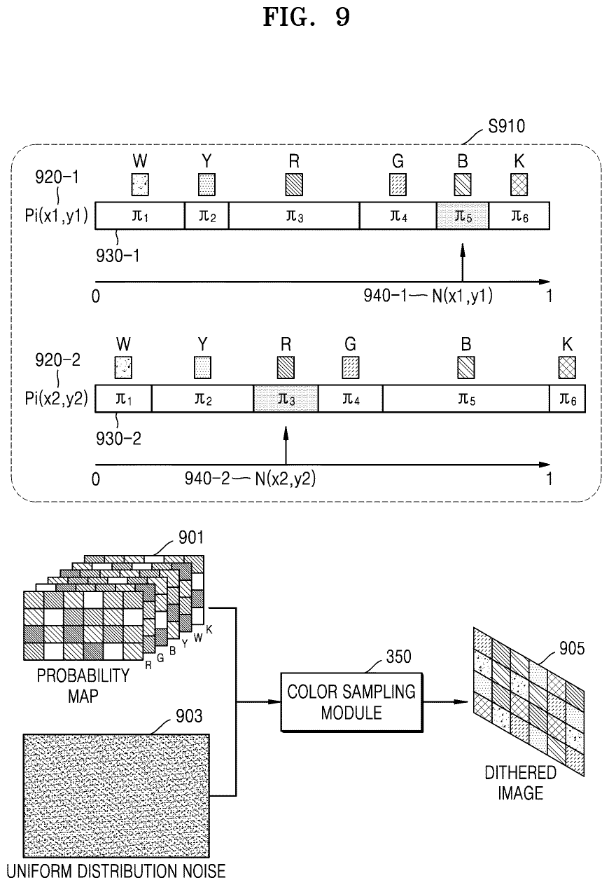

A specific operation performed by the electronic device 2000 to perform color sampling is described again with reference to FIG. 9.

In an embodiment of the disclosure, the electronic device 2000 may calculate an error for a first pixel of the input image, based on a difference between a color of the first pixel of the input image (or the preprocessed input image) and a color of a first pixel of the dithered image corresponding to the first pixel of the input image determined through sampling. In an embodiment of the disclosure, the error may include a difference between a color value of the first pixel of the input image and a color value of the first pixel of the dithered image. For example, when the color value of the first pixel of the input image is (255,100,100) and the color value of the first pixel of the dithered image is (125, 50, 50), the error for the first pixel of the input image may be (130, 50, 50).

In an embodiment of the disclosure, the electronic device 2000 may modify a color value of a second pixel of the input image, based on the error for the first pixel of the input image. In an embodiment of the disclosure, the electronic device 2000 may modify the color value of the second pixel of the input image by diffusing the error for the first pixel of the input image into the second pixel of the input image that is close to the first pixel of the input image. In an embodiment of the disclosure, the electronic device 2000 may calculate errors to be diffused into pixels around the first pixel of the input image by multiplying the error for the first pixel of the input image by diffusion coefficients (or weight values) of an error diffusion kernel. In an embodiment of the disclosure, the electronic device 2000 may obtain the modified color value of the second pixel of the input image by adding the error to be diffused into the second pixel of the input image, which is one of the errors to be diffused into the pixels around the first pixel of the input image, to the color value of the second pixel of the input image. In an embodiment of the disclosure, the color of the first pixel of the input image may be a color corresponding to the color value modified by at least one error diffused from other pixels around the first pixel in the input image, according to the method described above.

In an embodiment of the disclosure, the electronic device 2000 may adjust the modified color value of the second pixel of the input image so that the color value is within an allowable range. In an embodiment of the disclosure, adjusting the color value to be within the allowable range of the color value may be referred to as value clipping. In an embodiment of the disclosure, the electronic device 2000 may adjust, to a maximum value, a color value in which the modified color value is greater than the maximum value of the allowable range among the color values, and may adjust, to a minimum value, a color value in which the modified color value is lower than the lower limit value of the allowable range. For example, by adding the error to be diffused into the second pixel of the input image to the color value of the second pixel of the input image, the modified color value of the color of the second pixel of the input image may be (−100, 30, 290). In this case, because the allowable range of the color value is from 0 to 255 for each of R, G, and B channels, the electronic device 2000 may adjust the modified color value of the color of the second pixel of the input image to (0, 30, 255). In an embodiment of the disclosure, when the color modified by error diffusion is not out of the allowable range of the color value, the electronic device 2000 may not adjust the modified color value of the color.

In an embodiment of the disclosure, the electronic device 2000 may obtain weight values optimized to express a color corresponding to the modified color value, based on pre-stored weight value data. In an embodiment of the disclosure, the electronic device 2000 may determine the obtained optimized weight values as the probability value of the second pixel of the input image. In an embodiment of the disclosure, the electronic device 2000 may optimize weight values for the color corresponding to the modified color value of the second pixel of the input image. Because the operation performed by the electronic device 2000 to obtain the weight values optimized to express the modified color based on the pre-stored weight value data or to optimize the weight values for the modified color corresponds to the operation performed by the electronic device 2000 to obtain the weight values for the plurality of pixels of the input image, a redundant description thereof is omitted.

In an embodiment of the disclosure, the electronic device 2000 may determine the color of the second pixel of the dithered image corresponding to the second pixel of the input image by performing sampling based on the probability value of the second pixel of the input image and the uniform distribution noise. In an embodiment of the disclosure, the electronic device 2000 may calculate an error for the second pixel of the input image, based on a difference between the modified color of the second pixel of the input image and the color of the second pixel of the dithered image. In an embodiment of the disclosure, the electronic device 2000 may modify a color of a third pixel of the input image, based on the error for the second pixel. Because the error for the second pixel and the modifying of the color of the third pixel correspond to the error for the first pixel and the modifying of the color of the second pixel described above, a redundant description thereof is omitted.

In an embodiment of the disclosure, the electronic device 2000 may sequentially obtain errors for the plurality of pixels of the input image and may sequentially diffuse the obtained errors to neighboring pixels. In an embodiment of the disclosure, the electronic device 2000 may obtain the dithered image by sampling the optimized weight value for the modified color as the probability value, based on the diffused errors. For example, the electronic device 2000 may diffuse the error for the first pixel disposed at the leftmost side of the first line of the input image into the pixels around the first pixel. When the electronic device 2000 obtains the error for the second pixel disposed on the right side of the first pixel, the error for the second pixel may be diffused into the neighboring pixels excluding the first pixel. In the same manner, the electronic device 2000 may sequentially obtain errors for pixels disposed in the first line of the input image while moving to the right and diffuse the obtained errors to the neighboring pixels. When the errors of all pixels disposed in the first line are diffused, the electronic device 2000 may diffuse errors of pixels disposed in the second line in the same manner as the pixels disposed in the first line.

As such, when performing sampling to select the colors of the plurality of pixels of the dithered image based on the probability values of the plurality of pixels of the input image, the electronic device 2000 according to an embodiment of the disclosure may apply an error diffusion algorithm in which the color values of the neighboring pixels are considered on a pixel-by-pixel basis to select the colors for the pixels of the dithered image. Accordingly, a detailed expressiveness of the dithered image may be further improved.

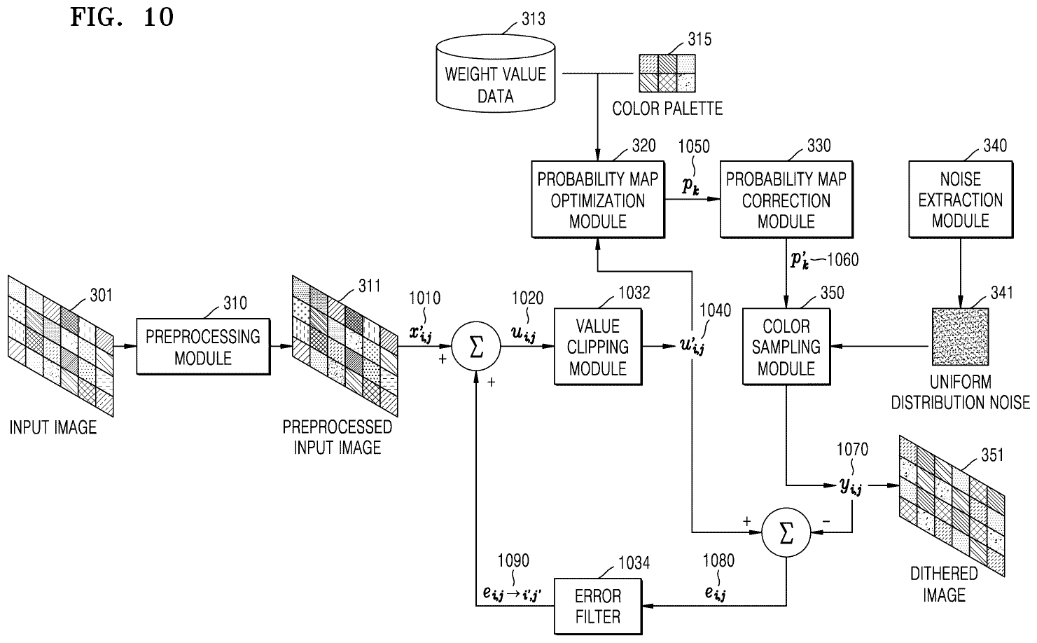

A detailed operation performed by the electronic device 2000 to obtain the dithered image based on the error diffusion algorithm is described again below with reference to FIG. 10.

In an embodiment of the disclosure, the electronic device 2000 may display the dithered image on a display. In an embodiment of the disclosure, the display may be a display capable of using or expressing only the plurality of colors of the color palette.

In an embodiment of the disclosure, the electronic device 2000 may store, in the memory, a look-up table in which signals input to a preset display are respectively mapped to the plurality of colors of the color palette. In an embodiment of the disclosure, the electronic device 2000 may identify signals corresponding to the plurality of pixels of the dithered image, based on the look-up table pre-stored in the memory, and may input the identified signals to the display. In an embodiment of the disclosure, the display may display the dithered image by controlling the plurality of pixels of the display to express one of the plurality of colors of the color palette, based on an input signal. In an embodiment of the disclosure, the pixels of the display may include a plurality of particles (e.g., electronic ink capsules) respectively corresponding to the plurality of colors. In an embodiment of the disclosure, each of the plurality of particles may be moved toward or away from the surface of the pixel according to a preset electric field. In an embodiment of the disclosure, the display may control the pixel to express one of the plurality of colors of the color palette by moving the plurality of particles of the pixel through an electric field corresponding to an input signal. In this case, the plurality of particles may respectively express the plurality of colors of the color palette, or two or more of the plurality of particles may be combined to express a specific color of the color palette.

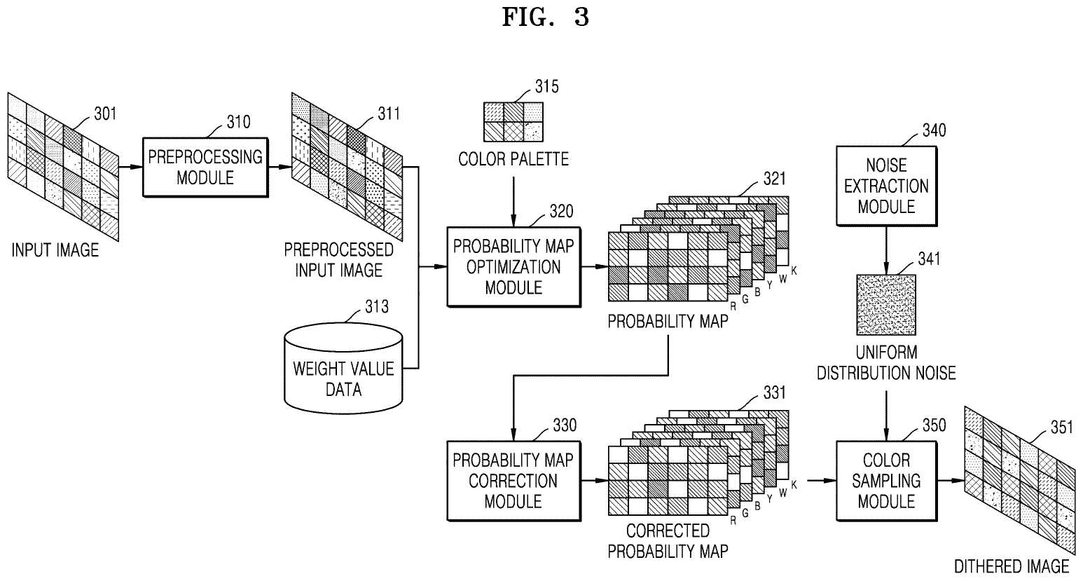

FIG. 3 is a diagram illustrating an operation performed by an electronic device 2000 to dither an image, according to an embodiment of the disclosure.

Referring to FIG. 3, the electronic device 2000 may include at least one of a preprocessing module 310, a probability map optimization module 320, a probability map correction module 330, a noise extraction module 340, or a color sampling module 350. In the disclosure, the operations and functions of the preprocessing module 310, the probability map optimization module 320, the probability map correction module 330, the noise extraction module 340, and the color sampling module 350 may be understood as the operations and functions of the electronic device 2000 or at least one processor of the electronic device 2000.

In an embodiment of the disclosure, the electronic device 2000 may obtain an input image 301. In an embodiment of the disclosure, the input image 301 may be an image stored in the memory of the electronic device 2000 or an image received from the external electronic device. In an embodiment of the disclosure, a plurality of pixels of the input image 301 may express more colors than a plurality of colors of a color palette of a display. In an embodiment of the disclosure, the electronic device 2000 may input the obtained input image 301 of the preprocessing module 310.

In an embodiment of the disclosure, the electronic device 2000 may obtain a preprocessed input image 311 by performing preprocessing on the input image 301 through the preprocessing module 310. In an embodiment of the disclosure, the preprocessing module 310 may obtain the preprocessed input image 311 by performing preprocessing, including at least one of gamma correction or color gamut compression, on the input image 301. In an embodiment of the disclosure, the electronic device 2000 may input the preprocessed input image 311 to the probability map optimization module 320.

In an embodiment of the disclosure, no preprocessing may be performed on the input image 301. In other words, the electronic device 2000 may input the input image 301 to the probability map optimization module 320 without performing preprocessing on the input image 301 through the preprocessing module 310. However, for the convenience of explanation, it is assumed that the preprocessed input image 311 is input to the probability map optimization module 320. Accordingly, the preprocessed input image 311 described below may be understood as being replaced with the input image 301.

In an embodiment of the disclosure, the electronic device 2000 may obtain a probability map 321 of the preprocessed input image 311 through the probability map optimization module 320. In an embodiment of the disclosure, the electronic device 2000 may input the preprocessed input image 311, pre-stored weight value data 313, and a color palette 315 to the probability map optimization module 320. In an embodiment of the disclosure, the probability map optimization module 320 may optimize the probability map 321 based on the preprocessed input image 311, the pre-stored weight value data 313, and the color palette 315. In an embodiment of the disclosure, the optimizing of the probability map 321 may mean obtaining the probability map 321 that includes, as probability values, weight values optimized to express the colors of the plurality of pixels of the preprocessed input image 311 by performing a weighted sum operation on the plurality of colors of the color palette 315. In an embodiment of the disclosure, the electronic device 2000 may optimize the probability map 321 by obtaining, from the pre-stored weight value data, the weight values optimized to express the colors of the plurality of pixels of the preprocessed input image 311. In an embodiment of the disclosure, the electronic device 2000 may input the probability map 321 to the probability map correction module 330.

In an embodiment of the disclosure, when the electronic device 2000 does not include the pre-stored weight value data 313 or when the pre-stored weight value data 313 is not input to the probability map optimization module 320, the probability map optimization module 320 may optimize the probability map 321 of the preprocessed input image 311 based on the preprocessed input image 311 and the color palette 315. In other words, although FIG. 3 illustrates that the pre-stored weight value data 313 is input to the probability map optimization module 320, the probability map optimization module 320 may optimize the probability map 321 of the preprocessed input image 311 even when the pre-stored weight value data 313 is not input.

In an embodiment of the disclosure, the electronic device 2000 may obtain a probability map 331 corrected through the probability map correction module 330. In an embodiment of the disclosure, the probability map correction module 330 may obtain the corrected probability map 331 by performing at least one of first probability correction that adjusts a probability value less than or equal to a threshold value to zero with respect to the probability map 321 or second probability correction that is temperature scaling for the probability value. In an embodiment of the disclosure, the electronic device 2000 may input the corrected probability map 331 to the color sampling module 350.

In an embodiment of the disclosure, no probability map correction may be performed on the probability map 321. In other words, the electronic device 2000 may input the probability map 321 to the color sampling module 350 without performing probability correction on the probability map 321 through the probability map correction module 330. However, for the convenience of explanation, it is assumed that the corrected probability map 331 is input to the color sampling module 350. Accordingly, the corrected probability map 331 described below may be understood as being replaced with the probability map 321.

In an embodiment of the disclosure, the electronic device 2000 may obtain uniform distribution noise 341 through the noise extraction module 340. In an embodiment of the disclosure, the uniform distribution noise may include blue noise. In an embodiment of the disclosure, the noise extraction module 340 may obtain uniform distribution noise corresponding to the input image 301, based on a plurality of pre-stored noise samples. The uniform distribution noise corresponding to the preprocessed input image 301 may refer to noise which has the same size as the size of the input image 301 and in which noise values respectively corresponding to the plurality of pixels follow a uniform distribution. In an embodiment of the disclosure, the uniform distribution noise 341 may include noise having a first frequency characteristic in a first area corresponding to an object area of the input image 301 and noise having a second frequency characteristic in the remaining area excluding the object area of the input image 301. In an embodiment of the disclosure, the electronic device 2000 may input the uniform distribution noise 341 to the color sampling module 350.

In an embodiment of the disclosure, the electronic device 2000 may obtain a dithered image 351 through the color sampling module 350. In an embodiment of the disclosure, the color sampling module 350 may obtain the dithered image 351 corresponding to the input image 301 by performing sampling based on the corrected probability map 331 and the uniform distribution noise 341. In an embodiment of the disclosure, the color sampling module 350 may obtain a cumulative distribution function for the plurality of colors of the color palette 315 of the plurality of pixels of the preprocessed input image 311, based on the probability values of the plurality of pixels of the corrected probability map 331. In an embodiment of the disclosure, the color sampling module 350 may determine the color of each of the plurality of pixels of the dithered image 351 corresponding to the plurality of pixels of the preprocessed input image 311 as one of the plurality of colors of the color palette 315 by performing inverse transform sampling based on the value of the uniform distribution noise 341 and the cumulative distribution function.

FIG. 4 is a diagram illustrating an operation performed by the electronic device to preprocess an image, according to an embodiment of the disclosure.

Referring to FIG. 4, the preprocessing module 310 may obtain a preprocessed input image 404 by performing preprocessing on an input image 402. The input image 402 and the preprocessed input image 404 may correspond to the input image 301 and the preprocessed input image 311 of FIG. 3.

In an embodiment of the disclosure, the preprocessing of the input image 402 may include at least one of gamma correction or color gamut compression. In other words, the preprocessing module 310 may perform at least one of gamma correction or color gamut compression on the input image 402.

In an embodiment of the disclosure, the preprocessing module 310 may perform gamma correction on the input image 402 (S410). That is, the preprocessed input image 404 may be an image obtained by performing gamma correction on the input image 402. In an embodiment of the disclosure, the preprocessing module 310 may perform gamma correction on the input image 402, based on the following equation.

$$\begin{matrix}Equation 1 & \\ f ( x ) = 255 {( \frac{x}{255} )}^{r} & Eqn ( 1 )\end{matrix}$$

x corresponds to one of RGB values of the plurality of pixels of the input image 402 and r corresponds to a gamma value of the gamma correction. The gamma correction may be individually applied to each of the plurality of pixels of the image. The preprocessing module 310 may obtain corrected RGB values of the plurality of pixels of the input image 402 by performing gamma correction on the input image 402. The preprocessing module 310 may obtain a gamma-corrected input image (e.g., preprocessed input image 404) by converting the RGB values of the plurality of pixels of the input image 402 into the obtained corrected RGB values.

In an embodiment of the disclosure, the preprocessing module 310 may adjust the gamma value of the gamma correction, based on brightness values of the plurality of colors of the color palette. In an embodiment of the disclosure, brightness of a specific color or a pixel of a specific color may be calculated based on the following equation.

$$\begin{matrix}Equation 2 & \\ L = 0.2126 \cdot R + 0.7152 \cdot G + 0.0722 \cdot B & Eqn ( 2 )\end{matrix}$$

L corresponds to the brightness value of the color or the pixel, and R, G, and B correspond to the RGB values of the color or the pixel, respectively.

For example, the preprocessing module 310 may determine an initial set gamma value of the gamma correction to be 1.8. The preprocessing module 310 may calculate the brightness of the plurality of colors of the color palette. When an average of the calculated brightness of the plurality of colors of the color palette is less than or equal to 100, the preprocessing module 310 may increase the gamma value from 1.8 to 2.2. In contrast, when an average of the calculated brightness of the plurality of colors is greater than 200, the preprocessing module 310 may decrease the gamma value from 1.8 to 1.4. As another example, when the number of colors having brightness of less than or equal to 100 among the plurality of colors of the color palette is four or more, the preprocessing module 310 may increase the gamma value from 1.8 to 2.2. In contrast, when the number of colors having brightness of less than or equal to 100 among the plurality of colors of the color palette is 1 or less, the preprocessing module 310 may decrease the gamma value from 1.8 to 1.4. However, the disclosure is not necessarily limited to the example described above, and the brightness value, the number of colors, and the gamma value may be determined differently according to a user input or a design method of the preprocessing module 310.

In an embodiment of the disclosure, the preprocessing module 310 may perform color gamut compression on the input image 402 (S420). That is, the preprocessed input image 404 may be an image obtained by compressing the color gamut of the input image 402. In an embodiment of the disclosure, the preprocessing module 310 may perform color gamut compression, based on the following equation.

$$\begin{matrix}Equation 3 & \\ f ( x ) = min ( ( \frac{x - 128}{256} ) , ηtanh ( \frac{( \frac{x - 128}{256} )}{η} ) ) & Eqn ( 3 )\end{matrix}$$

$$\begin{matrix}Equation 4 & \\ f ( x ) = max ( ( \frac{x - 128}{256} ) , ηtanh ( \frac{( \frac{x - 128}{256} )}{η} ) ) & Eqn ( 4 )\end{matrix}$$

x may correspond to a Cb value or a Cr value in a YCbCr color space of the pixel of the input image 402, and η may correspond to a scaling parameter of color gamut compression. As the scaling parameter is closer to 0, the range of the Cb value or the Cr value of the plurality of pixels of the input image 402 may be reduced, compared to an original range. In addition, Equation 3 above may be applied to color gamut compression that decreases the Cb value or the Cr value. Equation 4 above may be applied to color gamut compression that increases the Cb value or the Cr value.

In an embodiment of the disclosure, the preprocessing module 310 may determine at least one of a scaling parameter of the color gamut compression or a direction of the color gamut compression so that the gamut of the plurality of pixels of the input image 402 is included in the color gamut of the plurality of colors of the color palette.

For example, when the Cb values of the color gamut of the plurality of pixels of the input image 402 is greater than the Cb values of the color gamut of the plurality of colors of the color palette (or the maximum Cr value of the plurality of colors of the color palette), the preprocessing module 310 may decrease the Cb values of the plurality of pixels of the input image 402 to be less than or equal to the Cb values of the color gamut of the plurality of colors of the color palette. As another example, when the Cr values of the color gamut of the plurality of pixels of the input image 402 is less than the Cr values of the color gamut of the plurality of colors of the color palette (or the minimum Cr value of the plurality of colors of the color palette), the preprocessing module 310 may increase the Cr values of the plurality of pixels of the input image 402 to be greater than or equal to the Cb values of the color gamut of the plurality of colors of the color palette.

In an embodiment of the disclosure, the preprocessing module 310 may perform both gamma correction and color gamut compression on the input image 402. That is, the preprocessed input image 404 may be an image obtained by performing both gamma correction and color gamut compression on the input image 402. In this case, the preprocessed input image 404 may be obtained by performing remaining preprocessing on an image obtained by performing one of gamma correction and color gamut compression.

As such, according to an embodiment of the disclosure, the preprocessed input image 404 may be obtained by performing preprocessing, including at least one of gamma correction or color gamut compression, on the input image 402. The preprocessed input image 404 may be an image in which brightness, luminance, and saturation for specific colors are relatively reduced, compared to the input image 402. When expressed in the plurality of colors of the color palette with a limited number of colors and a limited brightness, the preprocessed input image 404 may prevent a phenomenon in which a desired color is not properly expressed and a color is saturated. In other words, the dithered image obtained based on the preprocessed input image 404 may be an image with improved expressiveness for the plurality of colors of the color palette that lacks expressiveness.

FIG. 5 is a diagram illustrating an operation performed by an electronic device to optimize a probability map, according to an embodiment of the disclosure.

Referring to FIG. 5, a probability map optimization module 320 may obtain a probability map 503 by performing probability map optimization on an input image 501. The input image 501 may correspond to the input image 301 or the preprocessed input image 311 of FIG. 3, and the probability map 503 may correspond to the probability map 321 of FIG. 3.

In an embodiment of the disclosure, the probability map 503 may include a plurality of channels respectively corresponding to a plurality of colors of a color palette 315. In an embodiment of the disclosure, probability values of a plurality of pixels of the probability map 503 may correspond to weight values optimized to express colors of a plurality of pixels of the input image 501 by performing a weighted sum operation on the plurality of colors of the color palette 315. In other words, the probability map optimization module 320 may update the probability map 503 so that the probability values of the plurality of pixels of the probability map 503 correspond to the weight values optimized to express the colors of the plurality of pixels of the input image 501 by performing the weighted sum operation on the plurality of colors of the color palette 315.

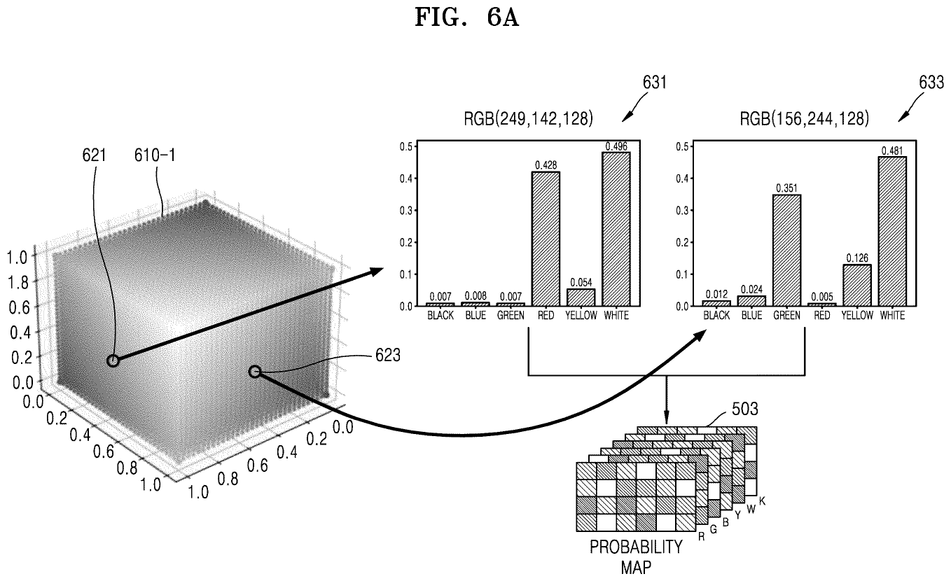

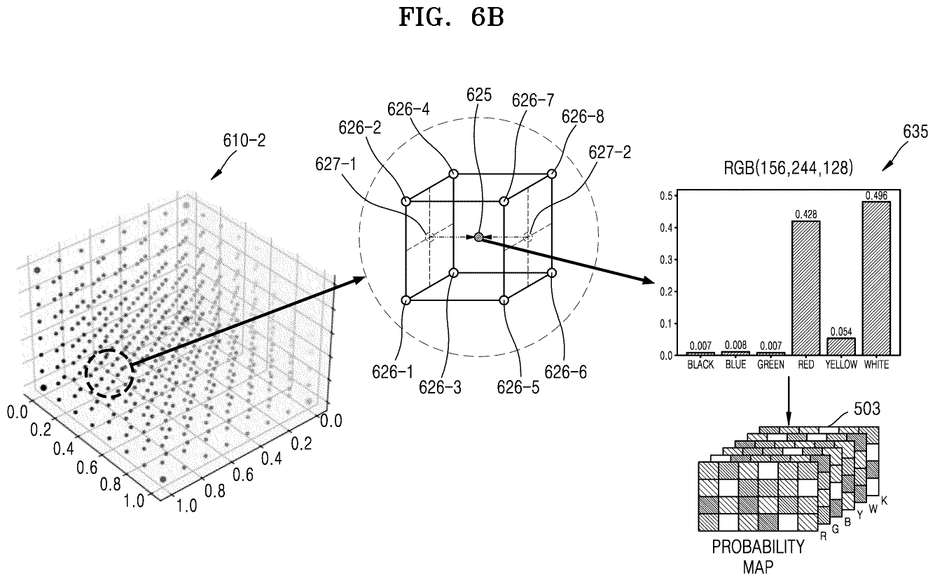

In an embodiment of the disclosure, the probability map optimization module 320 may perform probability map optimization based on pre-stored weight value data 313 (S510). In an embodiment of the disclosure, the probability map optimization module 320 may obtain the weight values optimized to express the colors of the plurality of pixels of the input image 501 by performing the weighted sum operation on the plurality of colors of the color palette 315, based on the pre-stored weight value data 313. In an embodiment of the disclosure, the optimized weight values may be respectively obtained for the plurality of pixels of the input image 501. In an embodiment of the disclosure, the probability map optimization module 320 may obtain the probability map 503 of the input image 501 that includes the optimized weight values as the probability values of the plurality of pixels. In an embodiment of the disclosure, the weight values for the plurality of colors of the color palette obtained from the pre-stored weight value data 313 may be determined as the probability values of the plurality of channels corresponding to the plurality of colors of the color palette of the probability map 503. The operation performed by the probability map optimization module 320 to obtain the weight values optimized to express the colors of the plurality of pixels, based on the pre-stored weight value data 313, is described again in detail with reference to FIGS. 6A and 6B.

In an embodiment of the disclosure, the pre-stored weight value data 313 may include optimized weight values for a plurality of preset colors. The optimized weight values for the plurality of preset colors may refer to weight values optimized to express the plurality of preset colors by performing the weighted sum operation on the plurality of colors of the color palette 315. In an embodiment of the disclosure, the probability map optimization module 320 may optimize the weight values for the plurality of preset colors. In an embodiment of the disclosure, the probability map optimization module 320 may obtain a weighted-sum color by performing the weighted sum operation on weight values prior to optimization for the plurality of colors of the color palette 315. The weight values to be optimized may be weight values that are normalized (e.g., values obtained through a softmax function) and may be weight values optimized so that the sum of the weight values applied to the plurality of colors of the color palette 315 is equal to 1. In an embodiment of the disclosure, the probability map optimization module 320 may optimize the weight values for the respective preset colors by obtaining weight values that minimize MSE loss with respect to the weighted-sum color for the plurality of preset colors. For example, the probability map optimization module 320 may optimize weight values by applying gradient descent to the MSE loss function, and the disclosure is not necessarily limited to the example described above. In an embodiment of the disclosure, the probability map optimization module 320 may store the obtained optimized weight values as the pre-stored weight value data 313.

In an embodiment of the disclosure, the probability map optimization module 320 may perform probability map optimization based on the input image 501 (S520). In an embodiment of the disclosure, the probability map optimization module 320 may obtain the probability map 503 including the optimized weight values as the probability values of the plurality of pixels by optimizing the weight values for the colors of the plurality of colors of the color palette 315. In an embodiment of the disclosure, the probability map optimization module 320 may obtain a weighted-sum image 505 by performing the weighted sum operation on the probability values of the probability map 503 prior to optimization for the plurality of colors of the color palette 315. In an embodiment of the disclosure, the probability map optimization module 320 may update the probability map 503 based on a difference between the input image 501 and the weighted-sum image 505. In an embodiment of the disclosure, the updating of the probability map 503 may be performed for each of the plurality of pixels of the probability map on a pixel-by-pixel basis. The updating of the probability map 503 may refer to obtaining the probability values of the probability map 503 that minimize the MSE loss between the color values of the plurality of pixels of the input image 501 and the color values of the plurality of pixels of the weighted-sum image 505. For example, the probability map optimization module 320 may optimize the probability map 503 by applying gradient descent to the MSE loss function for each of the plurality of pixels of the probability map 503, but the disclosure is not necessarily limited to the example described above.

FIGS. 6A and 6B are diagrams illustrating an operation performed by the electronic device 2000 to obtain optimized weight values from pre-stored weight value data, according to an embodiment of the disclosure. The operation of the electronic device 2000 described with reference to FIGS. 6A and 6B may be understood as the operation of the probability map optimization module 320 of FIG. 5.

Referring to FIG. 6A, the electronic device 2000 may store pre-stored weight value data 610-1 in memory. In an embodiment of the disclosure, the pre-stored weight value data 610-1 may include optimized weight values for true colors, which are a combination of all colors expressible in a 24-bit color mode. In other words, the pre-stored weight value data 610-1 may include weight values respectively applied to a plurality of colors of the color palette optimized to express about 16.77 million colors, which are true colors, by performing a weighted sum operation on the plurality of colors of the color palette.

In an embodiment of the disclosure, the electronic device 2000 may obtain weight values optimized to express the colors of the plurality of pixels of the input image by performing the weighted sum operation on the plurality of colors of the color palette based on the pre-stored weight value data 610-1. For example, when a color value of a color of a first pixel in the input image is (249, 142, 128), the electronic device 2000 may obtain weight values 631 for the color having a color value of (249, 142, 128) from the pre-stored weight value data 610-1 as the weight value for the color of the first pixel. In addition, when a color value of a color of a second pixel in the input image is (156, 244, 128), the electronic device 2000 may obtain weight values 633 for the color having a color value of (156, 244, 128) from the pre-stored weight value data 610-1 as the weight value for the color of the second pixel.

In an embodiment of the disclosure, the electronic device 2000 may obtain the probability map 503 of the input image that includes optimized weight values obtained from the pre-stored weight value data 610-1 as the probability values of the plurality of pixels. For example, the weight values 631 for the color of the first pixel may be determined as the probability values of the plurality of channels of the first pixel in the probability map, and the weight values 633 for the color of the second pixel may be determined as the probability values of the plurality of channels of the second pixel in the probability map. In this case, the plurality of channels of the probability map 503 may respectively correspond to the plurality of colors of the color palette.

Referring to FIG. 6B, the electronic device 2000 may store pre-stored weight value data 610-2 in memory. In an embodiment of the disclosure, the lightweight pre-stored weight value data 610-2 may include optimized weight values for colors of a limited color space in which the values of respective RGB channels are spaced apart from each other by 4. In other words, the lightweight pre-stored weight value data 610-2 may include weight values respectively applied to a plurality of colors of the color palette optimized to express about 260,000 colors by performing a weighted sum operation on the plurality of colors of the color palette. In this case, because the lightweight pre-stored weight value data 610-2 has a size that is about 0.015 times greater than the pre-stored weight value data 610-1 of FIG. 6A, the size of the memory required to store the lightweight pre-stored weight value data 610-2 and the time required to obtain the weight value data may be reduced, compared to the pre-stored weight value data 610-1.

In an embodiment of the disclosure, the electronic device 2000 may identify a plurality of colors closest to the color 625 of the first pixel of the input image among the plurality of colors of the lightweight pre-stored weight value data 610-2. For example, because the lightweight pre-stored weight value data 610-2 includes fewer colors than true colors, the lightweight pre-stored weight value data 610-2 may not include the weight values for the color 625 of the first pixel among the plurality of pixels of the input image. In this case, the electronic device 2000 may identify eight colors 626-1 to 621-8 closest to the color 625 of the first pixel among the plurality of colors of the lightweight pre-stored weight value data 610-2. A distance between the colors may be determined based on an Euclidean distance between the color values. That is, the identified eight first to eighth colors 621-1 to 621-8 may be eight colors having the closest Euclidean distance between the color 625 of the first pixel and the color value. In an embodiment of the disclosure, the electronic device 2000 may interpolate weight values optimized to express the color of the first pixel based on weight values optimized to express a plurality of colors closest to the identified color of the first pixel. For example, the electronic device 2000 may obtain weight values for a first intermediate color 627-1, which is an average of weight values for the first to fourth colors 621-1 to 621-4 of the lightweight pre-stored weight value data 610-2, and weight values for a second intermediate color 672-2, which is an average of weight values for the fifth to eighth colors 621-5 to 621-8. The electronic device 2000 may obtain weight values 635 for the color 625 of the first pixel by performing distance-based interpolation on the weight values for the first intermediate color 627-1 and the weight values for the second intermediate color 672-2, based on the distance between the obtained first and second intermediate colors 627-1 and 627-2 and the color 625 of the first pixel.

As such, the electronic device according to an embodiment of the disclosure may obtain optimized weight values for the colors of the plurality of pixels of the input image from the pre-stored weight value data. Due to this, the weight values for the colors of the plurality of pixels of the input image may be obtained at a fast speed, compared to directly optimizing the weight values for the colors of the plurality of pixels of the input image. In addition, because the weight values for the colors of the plurality of pixels of the input image may be obtained even with optimized weight values for fewer colors than true colors, the capacity of the memory required to store the optimized weight values may be saved.

FIG. 7 is a diagram illustrating an operation performed by an electronic device to perform probability correction, according to an embodiment of the disclosure.

Referring to FIG. 7, a probability map correction module 330 may obtain a corrected probability map 703 by performing probability correction on a probability map 701. The probability map 701 and the corrected probability map 703 may respectively correspond to the probability map 321 and the corrected probability map 331 of FIG. 3. In an embodiment of the disclosure, the probability correction for the probability map 701 may include probability correction for probability values of a plurality of channels with respect to a plurality of pixels of the probability map 701. In an embodiment of the disclosure, the probability map correction module 330 may include at least one of first probability correction that adjusts a probability value less than or equal to a threshold value to zero or second probability correction that is temperature scaling for the probability value.

In an embodiment of the disclosure, the probability map correction module 330 may perform the first probability correction that adjusts a probability value less than or equal to the threshold value to zero with respect to the probability map 701 (S710). For example, the probability map correction module 330 may obtain a corrected probability 713 of the first pixel by performing the first probability correction on a probability 711 of the first pixel, which is one of the plurality of pixels of the probability map 701. The probability 711 of the first pixel may include probability values of a plurality of channels respectively corresponding to a plurality of colors of a color palette. When a threshold value Pₜₕ of the first probability correction is 0.03, the probability map correction module 330 may adjust, to zero, the probability values of black, blue, and green channels each having a probability value of 0.03 or less among the probabilities 711 of the first pixel. In addition, the probability map correction module 330 may redistribute the probability values of the black, blue, and green channels, which are adjusted to zero, to the probability values of the remaining channels, i.e., the red, yellow, and white channels. In this case, the probability values redistributed to the red, yellow, and white channels may be distributed to correspond to the ratios of the probability values of the red, yellow, and white channels.

As such, the electronic device 2000 according to an embodiment of the disclosure may adjust, to zero, the probability for the color of the color palette less than or equal to the threshold value through the first probability correction. The color of the color palette less than or equal to the threshold value may be considered as a color corresponding to noise that differs greatly from the actual color of the input image. In other words, by performing the first probability correction on the probability values of the plurality of pixels of the input image, the electronic device 2000 may prevent a case where the color corresponding to noise is sampled in the dithered image.

In an embodiment of the disclosure, the probability map correction module 330 may perform the second probability correction (S720), which is temperature scaling for the probability values, on the probability map 701. In an embodiment of the disclosure, the probability map correction module 330 may perform the temperature scaling based on the following equation.

$$\begin{matrix}Equation 5 & \\ {p}_{k} = \frac{exp ( {w}_{k} / τ )}{{\sum }_{k = 1}^{K} exp ( {w}_{k} / τ )} & Eqn ( 5 )\end{matrix}$$

wₖ may correspond to a probability value of a k^{th} channel among a plurality of channels of a specific pixel, and τ may correspond to a temperature parameter of the temperature scaling.

For example, the probability map correction module 330 may obtain a corrected probability 723 of the second pixel by performing the second probability correction on a probability 721 of the second pixel, which is one of the plurality of pixels of the probability map 701. The probability 721 of the second pixel may include probability values of a plurality of channels respectively corresponding to the plurality of colors of the color palette. When the temperature parameter τ of the temperature scaling is 0.3, the probability map correction module 330 may perform adjustment to decrease the probability values of the yellow, blue, black, and red channels, which have relatively smaller probability values than other channels, among the probabilities 721 of the second pixel, and may perform adjustment to increase the probability values of the green and white channels, which have relatively larger probability values than other channels.

In an embodiment of the disclosure, the probability map correction module 330 may determine the temperature parameter of the temperature scaling based on gradient values of the plurality of pixels of the input image. For example, the temperature parameter may be determined based on the following equation.

$$\begin{matrix}Equation 6 & \\ τ = f ( g ; β ) = sigmoid ( - 30 ( g - β ) ) & Eqn ( 6 )\end{matrix}$$

g may correspond to the magnitude of the gradient of the pixel, and β may correspond to a shift parameter for determining a position where the temperature parameter is 0.5.

In an embodiment of the disclosure, the value of the shift parameter may be adjusted based on text included in the input image. For example, the value of the shift parameter may be set to 0.3 by default. The probability map correction module 330 may adjust the value of the shift parameter to 0.1 when the quantitative criteria of the text meet a predefined condition, such as a case where the input image includes text, a case where the proportion of a region occupied by the included text is greater than or equal to a threshold value, or a case where the number of included texts is greater than or equal to a threshold value. As the value of the shift parameter approaches zero, the temperature parameter of the temperature scaling for the probability value of the pixel corresponding to a boundary line in the input image may approach 0.

As such, the electronic device 2000 according to an embodiment of the disclosure may perform probability correction so that a probability distribution becomes more concentrated around the highest probability when the input image includes a lot of text or as a pixel in the input image has a greater magnitude of gradient. When sampling is performed according to the corrected probability, a color with a higher probability value may be selected with a higher probability. This may reduce noise in the boundary line of the dithered image or a phenomenon in which the shape of the boundary line appears as a stair or sawtooth shape.

FIG. 8 is a diagram illustrating an operation performed by the electronic device to obtain uniform distribution noise, according to an embodiment of the disclosure.

Referring to FIG. 8, a noise extraction module 340 may obtain uniform distribution noise 830. The uniform distribution noise 830 may correspond to the uniform distribution noise 341 of FIG. 3.

In an embodiment of the disclosure, the uniform distribution noise 830 may be noise corresponding to an input image 820. In an embodiment of the disclosure, the uniform distribution noise 830 may include blue noise. For example, the uniform distribution noise 830 may include a plurality of noise values respectively corresponding to the plurality of pixels of the input image 820. In an embodiment of the disclosure, the plurality of noise values of the uniform distribution noise 830 may have a value between 0 and 1 and may have a low spatial correlation with neighboring noise values, and the values may be uniformly distributed. In addition, in a frequency domain, energy of high frequency components may be higher than energy of low frequency components. The human eye may be relatively sensitive to low frequency patterns in an image and insensitive to high frequency components. Accordingly, when blue noise is used for sampling to determine the colors of the plurality of pixels of a dithered image to be described below, a dithered image that is natural to a user's eyes may be obtained.

In an embodiment of the disclosure, the noise extraction module 340 may obtain the uniform distribution noise 830 based on at least one pre-stored noise sample. In an embodiment of the disclosure, the at least one pre-stored noise sample may include a plurality of noises having different frequency characteristics. For example, the at least one pre-stored noise sample may include at least one of a first noise sample 810-1 in which a density adjustment parameter σ_{BN} of blue noise is 1.0 or a second noise sample in which a density adjustment parameter σ_{BN} is 1.9. The noise extraction module 340 may obtain the uniform distribution noise 830 by determining noise values obtained from at least one of the first noise sample 810-1 or the second noise sample 810-2 as noise values corresponding to the plurality of pixels of the input image 820.

In an embodiment of the disclosure, in the uniform distribution noise 830, noise corresponding to an object area 821 of the input image 820 may have a first frequency characteristic, and noise corresponding to the remaining area 822 excluding the object area 821 of the input image 820 may have a second frequency characteristic. In an embodiment of the disclosure, the second frequency characteristic may have fewer high frequency components and more low frequency components in the frequency response than the first frequency characteristic.

In an embodiment of the disclosure, the noise extraction module 340 may identify the object area 821, which is an area occupied by the object in the input image 820, and the remaining area 822 excluding the object area. The remaining area 822 may be referred to as a background area. In an embodiment of the disclosure, the noise extraction module 340 may determine the noise values obtained from different noise samples as the noise values corresponding to the object area 821 and the remaining area 822. In an embodiment of the disclosure, the noise sample from which the noise value corresponding to the object area 821 is obtained may have fewer high frequency components and more low frequency components in the frequency response than the noise sample from which the noise value corresponding to the remaining area 822 is obtained.

For example, the noise extraction module 340 may determine the noise value obtained from the first noise sample 810-1 as noise 830-1 corresponding to the object area 821. In addition, the noise extraction module 340 may determine the noise value obtained from the second noise sample 810-2 as noise 830-2 corresponding to the remaining area 822. The noise extraction module 340 may obtain the noise 830-1 corresponding to the object area 821 and the noise 830-2 corresponding to the remaining area 822 as the uniform distribution noise 830. The second noise sample 810-1 may be blue noise having a higher density adjustment parameter of blue noise than the first noise sample 810-2. In other words, as the density adjustment parameter of the blue noise increases, the high frequency components decreases and the low frequency components increases in the frequency response of the noise. Accordingly, in the frequency characteristic of the noise 830-1 corresponding to the object area 821, the high frequency components may decrease and the low frequency components may increase in the frequency response, compared to the frequency characteristic of the noise 830-2 corresponding to the remaining area 822.

In an embodiment of the disclosure, the noise extraction module 340 may identify the object area 821 and the remaining area 822 included in the input image 820 by applying the input image 820 to a segmentation model. The segmentation model may include an artificial intelligence model that receives an image as input and identifies an object area included in the image and a remaining area excluding the object area. In an embodiment of the disclosure, the segmentation model may be included in the noise extraction module 340 or may be included in the electronic device 2000 as a separate module from the noise extraction module 340.

In an embodiment of the disclosure, the segmentation model may include a semantic segmentation model. The semantic segmentation model may output, as an object detection result, a segmentation map in which the plurality of pixels of the input image are assigned unique values that distinguish from each other with respect to each of a plurality of preset classes. In an embodiment of the disclosure, the noise extraction module 340 may identify, as the object area 821, a plurality of pixels assigned as the object in the object detection result obtained from the input image 820, and may identify, as the background area 822, a plurality of pixels assigned as a background. In an embodiment of the disclosure, the segmentation model may be trained based on training images including objects of various classes and training data sets including the training segment maps corresponding thereto.

As such, the uniform distribution noise according to an embodiment of the disclosure may include noise having different frequency characteristics in each of the object area of the input image and the remaining area excluding the object area. As noise has more high frequency components and fewer low frequency components in the frequency response, the area of the dithered image obtained based on the corresponding noise may have higher sharpness. In contrast, as noise has fewer high frequency components and more low frequency components in the frequency response, the area of the dithered image obtained by performing sampling based on the corresponding noise may be more natural. In other words, the electronic device according to an embodiment of the disclosure may obtain a dithered image, in which the object area has high sharpness and the background area, which is an area other than the object area, is natural, by applying noise corresponding to the input image differently depending on the area of the input image.

FIG. 9 is a diagram illustrating an operation performed by an electronic device to perform sampling, according to an embodiment of the disclosure.

Referring to FIG. 9, a color sampling module 350 may obtain a dithered image 905 based on a probability map 901 and uniform distribution noise 903. The probability map 901 may correspond to the probability map 321 or the corrected probability map 331 of FIG. 3, and the dithered image 905 may correspond to the dithered image 351 of FIG. 3. In addition, the operation of the color sampling module 350 based on the probability map 901 of FIG. 9 may be understood as an operation for a probability value of at least one pixel of an input image included in the probability map 901.

In an embodiment of the disclosure, the color sampling module 350 may perform sampling based on the probability map 901 and the uniform distribution noise 903 (S910). In an embodiment of the disclosure, the color sampling module 350 may obtain a cumulative distribution function for a plurality of colors of a color palette of a plurality of pixels of the input image, based on probability values of a plurality of pixels of the probability map 901.

For example, the color sampling module 350 may obtain a first cumulative distribution function 930-1 for a plurality of colors of a color palette of a first pixel of the input image, based on a probability value 920-1 of the first pixel of the probability map 901. In addition, the color sampling module 350 may obtain a second cumulative distribution function 930-2 for a plurality of colors of a color palette of a second pixel of the input image, based on a probability value 920-2 of the second pixel of the probability map 901. The first cumulative distribution function 930-1 and the second cumulative distribution function 930-2 may be cumulative distribution functions calculated by sequentially accumulating the probability values 920-1 of the first pixel and the probability values 920-2 of the second pixel in the order of white W, yellow Y, red R, green G, blue B, and black K.

In an embodiment of the disclosure, the color sampling module 350 may determine the colors of the plurality of pixels of the dithered image 905 corresponding to the plurality of pixels of the input image as one of the plurality of colors of the color palette by performing inverse transform sampling based on a cumulative distribution function and a noise value of uniform distribution noise 903.

In an embodiment of the disclosure, the color sampling module 350 may obtain a random number of inverse transform sampling for the plurality of pixels of the input image, based on the uniform distribution noise 903. In an embodiment of the disclosure, the random number of the inverse transform sampling may be a noise value itself corresponding to the plurality of pixels of the input image of the uniform distribution noise 903, or may be a value in a range between 0 and 1 calculated based on the noise value. In an embodiment of the disclosure, the color sampling module 350 may determine, as the color of the dithered image, a color corresponding to a section including the random number of the inverse transform sampling in the cumulative distribution function. In an embodiment of the disclosure, the section including the random number in the cumulative distribution function may be determined based on a sample selection condition for selecting a sample by comparing the random number with the cumulative distribution function. For example, in the cumulative distribution function, a section having the smallest probability value among sections having a probability value greater than the random number may be determined as the section including the random number, and the disclosure is not necessarily limited to the example described above. In an embodiment of the disclosure, the uniform distribution noise 903 may include blue noise. Because the blue noise has fewer low frequency components and more high frequency components in the frequency response, the dithered image obtained by performing sampling based on the blue noise may also form a color distribution having fewer low frequency components and more high frequency components in the frequency response.

For example, the color sampling module 350 may obtain a first random number 940-1 of inverse transform sampling for a first pixel, based on a noise value corresponding to the first pixel of the input image of the uniform distribution noise 903. The color sampling module 350 may determine blue B, which is a color corresponding to a section to which the first random number 940-1 belongs in the first cumulative distribution function 930-1, as a color corresponding to the first pixel of the input image in the dithered image 905. In addition, the color sampling module 350 may obtain a second random number 940-2 of inverse transform sampling for a second pixel, based on a noise value corresponding to the second pixel of the input image of the uniform distribution noise 903. The color sampling module 350 may determine red R, which is a color corresponding to a section to which the second random number 940-2 belongs in the second cumulative distribution function 930-2, as a color corresponding to the second pixel of the input image in the dithered image 905.

In an embodiment of the disclosure, the cumulative distribution function may form a probability distribution in which the plurality of colors of the color palette are accumulated in descending order of correlation with brightness. In an embodiment of the disclosure, the color sampling module 350 may identify the order of a plurality of colors of a color palette listed in descending order of correlation with brightness. In an embodiment of the disclosure, the color sampling module 350 may obtain a cumulative distribution function by accumulating probability values for a plurality of colors of the color palette of the probability map 901 according to the identified order of the plurality of colors of the color palette.

For example, the color sampling module 350 may determine the order of the plurality of colors of the color palette as white W, yellow Y, red R, green G, blue B, and black K by listing the plurality of colors of the color palette, that is, white W, yellow Y, red R, green G, blue B, and black K, in descending order of correlation with brightness. The color sampling module 350 may obtain a cumulative distribution function in which the probability values of the plurality of colors of the color palette are accumulated in the order of white W, yellow Y, green G, red R, blue B, and black K, based on the probability map 901.

As such, the electronic device according to an embodiment of the disclosure may perform sampling to determine the color of the dithered image, based on the probability values of the plurality of pixels of the probability map 901 and the noise values of the uniform distribution noise 903. Accordingly, the colors of the plurality of pixels of the dithered images may be selected so as to appear natural to the user's eyes, rather than being selected independently between adjacent pixels.

In addition, the cumulative distribution function according to an embodiment of the disclosure may be listed in descending order of correlation with brightness. Because the human eye is dependent on brightness, it may be perceived that more similar colors are selected as the difference in the random number of the inverse transform sampling is smaller, and dissimilar colors are selected as the difference in the random number of the inverse transform sampling is larger. In other words, the colors of the number of pixels of the dithered image may be determined to correspond to the characteristics of the random values of the inverse transform sampling. When the uniform distribution noise is blue noise having many high frequency components and many low frequency components, the dithered image may also form a color distribution according to the characteristics of the blue noise. Accordingly, the dithered image may form a color distribution that is more natural to a user's eyes.

FIG. 10 is a diagram illustrating an operation performed by an electronic device 2000 to dither an image based on error diffusion, according to an embodiment of the disclosure.

Referring to FIG. 10, the electronic device 2000 may include a preprocessing module 310, a probability map optimization module 320, a probability map correction module 330, a noise extraction module 340, a color sampling module 350, a value clipping module 1032, and an error filter 1034. Because the preprocessing module 310, the probability map optimization module 320, the probability map correction module 330, the noise extraction module 340, and the color sampling module 350 have been described with reference to FIG. 3, a redundant description thereof is omitted. In addition, the operations and functions of the value clipping module 1032 and the error filter 1034 in the disclosure may be understood as the operations and functions of the electronic device 2000 or at least one processor of the electronic device 2000.

In an embodiment of the disclosure, the electronic device 2000 may modify a color value 1010 of a first pixel based on an error diffused into the first pixel of a preprocessed input image 311. In an embodiment of the disclosure, the electronic device 2000 may obtain a modified color value 1020 of the first pixel by modifying the color value 1010 of the first pixel. In an embodiment of the disclosure, the error diffused into the first pixel may include an error diffused into the first pixel based on errors for pixels processed prior to the first pixel when the electronic device 2000 sequentially diffuses errors for a plurality of pixels of the preprocessed input image 311. In an embodiment of the disclosure, the electronic device 2000 may input the modified color value 1020 of the first pixel to the value clipping module 1032. In an embodiment of the disclosure, when there is no error diffused into the first pixel, the electronic device 2000 may input the color value 1010 of the first pixel to the probability map optimization module 320 described below, without modifying the color value of the first pixel. Accordingly, a clipped color value 1040 of the first pixel input to the probability map optimization module 320 described below may be understood as being replaced with the color value 1010 of the first pixel.

In an embodiment of the disclosure, the electronic device 2000 may perform value clipping on the modified color value 1020 of the first pixel through the value clipping module 1032. In an embodiment of the disclosure, the electronic device 2000 may obtain the clipped color value 1040 of the first pixel output from the value clipping module 1032. In an embodiment of the disclosure, when an input color value is out of an allowable range of a color value, the value clipping module 1032 may adjust the color value of the input pixel so that the color value is within the allowable range. In an embodiment of the disclosure, when the modified color value 1020 of the first pixel is not out of the allowable range of the color value, the electronic device 2000 may input the modified color value 1020 of the first pixel to the probability map optimization module 320 described below, without performing clipping on the modified color value 1020 of the first pixel. Accordingly, the clipped color value 1040 of the first pixel input to the probability map optimization module 320 described below may be understood as being replaced with the modified color value 1020 of the first pixel.

In an embodiment of the disclosure, the electronic device 2000 may obtain weight values optimized to express a color corresponding to the clipped color value 1040 of the first pixel through the probability map optimization module 320, and may determine the obtained optimized weight values as a probability value 1050 of the first pixel. In an embodiment of the disclosure, the electronic device 2000 may input the clipped color value 1040 of the first pixel, pre-stored weight value data 313, and a color palette 315 to the probability map optimization module 320. In an embodiment of the disclosure, the probability map optimization module 320 may optimize the probability value 1050 of the first pixel based on the clipped color value 1040 of the first pixel, the pre-stored weight value data 313, and the color palette 315. In an embodiment of the disclosure, the optimizing of the probability value 1050 of the first pixel may mean obtaining, as the probability value 1050 of the first pixel, weight values optimized to express a color corresponding to the clipped color value 1040 of the first pixel by performing a weighted sum operation on the plurality of colors of the color palette 315. In an embodiment of the disclosure, the probability map optimization module 320 may obtain weight values optimized to express the color corresponding to the clipped color value 1040 of the first pixel from the pre-stored weight value data 313, or may obtain the probability value 1050 of the first pixel by optimizing weight values for the color corresponding to the clipped color value 1040 of the first pixel. In an embodiment of the disclosure, the electronic device 2000 may input the probability value 1050 of the first pixel to the probability map correction module 330.

In an embodiment of the disclosure, a corrected probability value 1060 of the first pixel may be obtained through the probability map correction module 330. In an embodiment of the disclosure, the probability map correction module 330 may obtain the corrected probability value 1060 of the first pixel by performing at least one of first probability correction that adjusts a probability value less than or equal to a threshold value to zero with respect to the probability value 1050 of the first pixel or second probability correction that is temperature scaling for the probability value. In an embodiment of the disclosure, the electronic device 2000 may input the corrected probability value 1060 of the first pixel to the color sampling module 350. In an embodiment of the disclosure, the electronic device 2000 may input the probability value 1050 of the first pixel to the color sampling module 350 without performing probability correction on the probability value 1050 of the first pixel. Accordingly, the corrected probability value 1060 of the first pixel input to the color sampling module 350 described below may be understood as being replaced with the probability value 1050 of the first pixel.

In an embodiment of the disclosure, the probability map correction module 330 may determine a temperature parameter T of the temperature scaling based on a predefined sampling mode. In an embodiment of the disclosure, the pre-defined sampling mode may include a first sampling mode for obtaining a dithered image 351 greatly affected by an error diffusion effect and a second sampling mode for obtaining a dithered image 351 greatly affected by a blue noise effect. In an embodiment of the disclosure, the dithered image obtained according to the first sampling mode may have improved detailed expressiveness in that sampling is performed with a high error diffusion effect of each of the plurality of pixels of input images. On the other hand, the dithered image obtained according to the second sampling mode may be a natural image with less banding artifact because sampling is performed with a high reflection of the characteristics of blue noise, which is uniform distribution noise. In an embodiment of the disclosure, the probability map correction module 330 may obtain a user input for selecting a predefined sampling mode and may select a sampling mode corresponding to the obtained user input. In an embodiment of the disclosure, when the predefined sampling mode is the first sampling mode, the probability map correction module 330 may adjust the temperature parameter to be closer to zero. In an embodiment of the disclosure, when the predefined sampling mode is the second sampling mode, the probability map correction module 330 may adjust the temperature parameter to be closer to 1.

In an embodiment of the disclosure, the electronic device 2000 may obtain a color value 1070 of the first pixel of the dithered image 351 corresponding to the first pixel through the color sampling module 350. In an embodiment of the disclosure, the color sampling module 350 may determine the color of the first pixel of the dithered image 351 by performing sampling based on the corrected probability value 1060 of the first pixel and the uniform distribution noise 341. In an embodiment of the disclosure, the color sampling module 350 may obtain a cumulative distribution function for the plurality of colors of the color palette 315 of the first pixel of the input image, based on the corrected probability value 1060 of the first pixel of the input image. In an embodiment of the disclosure, the color sampling module 350 may determine the color of the first pixel of the dithered image 351 as one of the plurality of colors of the color palette 315 by performing inverse transform sampling based on the value of the uniform distribution noise 341 and the cumulative distribution function.

In an embodiment of the disclosure, the color sampling module 350 may determine whether to apply the noise value of the uniform distribution noise 341 as the random number for the inverse transform sampling, based on the predefined sampling mode. In an embodiment of the disclosure, when the predefined sampling mode is the first sampling mode, the color sampling module 350 may perform inverse transform sampling by applying a fixed value (e.g., 0.5) as the random number, instead of applying the noise value of the uniform distribution noise 341 as the random number for the inverse transform sampling. In an embodiment of the disclosure, when the predefined sampling mode is the second sampling mode, the color sampling module 350 may apply the noise value of the uniform distribution noise 341 as the random number for the inverse transform sampling. In this case, the inverse transform sampling may be performed based on the sample selection condition and the random number according to the following equation.

$$0.5 \leq F ( i ) + ( 0.5 - {n}_{blue} ) , \\ where {n}_{blue} ∼ U ( 0 , 1 ) \to ( 0.5 - {n}_{blue} ) ∼ U ( - 0.5 , 0.5 ) \qquad Equation 7$$

F(i) may correspond to a probability value accumulated up to a color of an i^{th} color palette in the cumulative distribution function, and n_{blue} may correspond to a noise value of blue noise, which is the uniform distribution noise 341. As such, the color sampling module 350 may perform sampling in which the characteristics of blue noise, which is the uniform distribution noise, are highly reflected by performing inverse transform sampling using a random number that is perturbed as the noise value of blue noise in the second sampling mode. In an embodiment of the disclosure, the electronic device 2000 may obtain an error 1080 for the first pixel of the preprocessed input image 311, based on a difference between the color value 1070 of the first pixel of the dithered image 351 and the clipped color value 1040 of the first pixel. In an embodiment of the disclosure, the electronic device 2000 may input the error 1080 for the first pixel to the error filter 1034.

In an embodiment of the disclosure, the electronic device 2000 may obtain an error 1090 to be diffused into neighboring pixels of the first pixel of the preprocessed input image 311 through the error filter 1034. The error 1090 to be diffused into the neighboring pixels of the first pixel may include an error to be diffused for each of a plurality of directions. In an embodiment of the disclosure, the error filter 1034 may calculate the error 1090 diffused around the first pixel, based on the error 1080 for the first pixel. In an embodiment of the disclosure, the error filter 1034 may include an error diffusion kernel that includes information about a plurality of directions in which the error is diffused and a diffusion coefficient for each of the plurality of directions. In an embodiment of the disclosure, the error filter 1034 may obtain the error 1090 to be diffused around the first pixel by multiplying the error 1080 for the first pixel by the diffusion coefficient for each of the plurality of directions of the error diffusion kernel. In an embodiment of the disclosure, the electronic device 2000 may diffuse the error 1090 to be diffused around the first pixel into the neighboring pixels of the first pixel located in a direction in which the error is diffused in the preprocessed image 311. For example, the electronic device 2000 may modify the color value of the second pixel by diffusing the error 1090, which is to be diffused into the neighboring pixels of the first pixel, into the second pixel located around the first pixel of the preprocessed image 311.

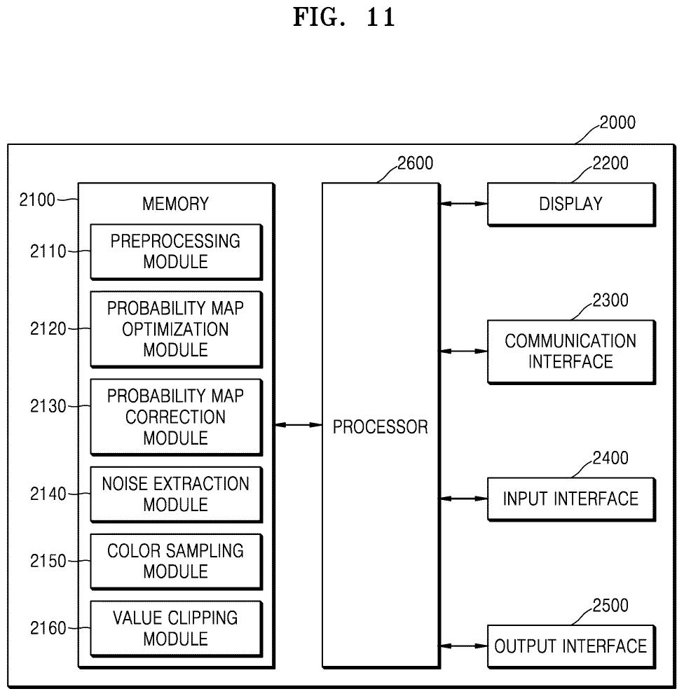

FIG. 11 is a detailed configuration diagram of an electronic device 2000 according to an embodiment of the disclosure.

Referring to FIG. 11, the electronic device 2000 may include memory 2100, a display 2200 a communication interface 2300, an input interface 2400, an output interface 2500, and a processor 2600. The memory 2100, the display 2200, the communication interface 2300, the input interface 2400, the output interface 2500, and the processor 2600 may be electrically and/or physically connected to each other.

The components illustrated in FIG. 11 are only an embodiment of the disclosure, and the components included in the electronic device 2000 are not limited to those illustrated in FIG. 11. The electronic device 2000 according to an embodiment of the disclosure may not include some of the components illustrated in FIG. 11, and may further include components not illustrated in FIG. 11.

The memory 2100 may store instructions or program code for performing the functions or operations of the electronic device 2000. In an embodiment of the disclosure, at least one instruction, algorithm, data structure, program code and application program stored in the memory 2100 may be implemented in, for example, programming or scripting languages, such as C, C++, Java, or assembler.

In an embodiment of the disclosure, the memory 2100 may include at least one of flash memory-type memory, hard disk-type memory, multimedia card micro-type memory, card-type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), mask ROM, flash ROM, hard disk drive (HDD), or solid state drive (SSD). The memory 2100 may not exist separately and may be configured to be included in the processor 2600. The memory 2100 may include a volatile memory, a non-volatile memory, or a combination of a volatile memory and a non-volatile memory. The memory 2100 may store a program or at least one instruction for performing operations according to an embodiment described below. The memory 2100 may provide the stored data to the processor 2600 in response to a request from the processor 2600.

In an embodiment of the disclosure, the memory 2100 may include at least one of a preprocessing module 2110, a probability map optimization module 2120, a probability map correction module 2130, a noise extraction module 2140, a color sampling module 2150, or a value clipping module 2160. In an embodiment of the disclosure, modules stored in the memory 2100 refer to units that process one function or operation of the electronic device 2000, and may be implemented as hardware included in the electronic device 2000, software stored in the electronic device 2000, or as a combination of hardware and software. That is, the operations and functions of the modules stored in the memory 2100 may be understood as the operations and functions of the electronic device 2000. The preprocessing module 2110, the probability map optimization module 2120, the probability map correction module 2130, the noise extraction module 2140, the color sampling module 2150, and the value clipping module 2160 may respectively correspond to the preprocessing module 310, the probability map optimization module 320, the probability map correction module 330, the noise extraction module 340, the color sampling module 350, and the value clipping module 1032 described above, and thus, a redundant description thereof is omitted.

In an embodiment of the disclosure, the memory 2100 may include optimized weight value data. In an embodiment of the disclosure, the optimized weight value data may include weight values optimized to express a plurality of preset colors by performing a weighted sum operation on a plurality of colors of a color palette. In an embodiment of the disclosure, the plurality of preset colors may include true colors, which are a combination of all colors expressible in a 24-bit color mode, or may include colors of a limited color space in which values of respective RGB channels are spaced apart from each other by 4. However, the disclosure is not necessarily limited to the example described above, and the memory 2100 may further include a variety of data necessary to perform the operations and functions of the electronic device 2000 disclosed in the present specification.

In an embodiment of the disclosure, the display 2200 is a component that displays images and/or videos. In an embodiment of the disclosure, the display 2200 may include an electronic ink display or an electronic paper display, which may display only colors of a limited color palette. However, the disclosure is not necessarily limited to the example described above, and the display 2200 may include a physical device that displays a dithered image based on a signal received from the processor 2700 or displays a screen (a user interface (UI), a graphical user interface (GUI), etc.) that performs various operations and functions of the electronic device 2000 of the disclosure.

The communication interface 2300 is a component that allows the electronic device 2000 to communicate with an external electronic device. In an embodiment of the disclosure, the communication interface 2300 may perform data communication between the electronic device 2000 and the external electronic device by using at least one of data communication schemes including wired local area network (LAN), wireless LAN, Wireless Fidelity (Wi-Fi), Bluetooth, ZigBee, Wi-Fi Direct (WFD), Infrared Data Association (IrDA), Bluetooth Low Energy (BLE), Near Field Communication (NFC), Wireless Broadband Internet (Wibro), World Interoperability for Microwave Access (WiMAX), Shared Wireless Access Protocol (SWAP), Wireless Gigabit Alliance (WiGig), and radio frequency (RF) communication.

In an embodiment of the disclosure, the communication interface 2300 may receive at least one of an input image, optimized weight value data, or a dithered image from the external electronic device, or may transmit at least one of an input image, optimized weight value data, or a dithered image to the external electronic device. In an embodiment of the disclosure, information received through the communication interface 2300 may be provided to the processor 2600. However, the disclosure is not necessarily limited to the example described above, and the communication interface 2300 may receive or transmit, from or to the external electronic device, a variety of data necessary to perform the operations and functions of the electronic device 2000 disclosed in the present specification.

The input interface 2400 is a component that receives various user inputs. In an embodiment of the disclosure, the input interface 2400 may include a touch panel, physical buttons, a microphone, etc. In an embodiment of the disclosure, information input through the input interface 2400 may be provided to the processor 2600. In an embodiment of the disclosure, the input interface 2400 may obtain a user input of selecting a sampling mode. However, the disclosure is not necessarily limited to the example described above, and the input interface 2400 may obtain a variety of data necessary to perform the operations and functions of the electronic device 2000 disclosed in the present specification.

The output interface 2500 is a component that allows the electronic device 2000 to provide a variety of information to the user. In an embodiment of the disclosure, the electronic device 2000 may include a speaker, which is a component that outputs sound. In an embodiment of the disclosure, the output interface 2500 may output a sound corresponding to at least one text included in the dithered image, based on a signal received from the processor 2600, or may output a sound including information related to image dithering. However, the disclosure is not necessarily limited to the example described above, and the output interface 2500 may output a variety of sounds or information necessary to perform the operations and functions of the electronic device 2000 disclosed in the present specification.

The processor 2600 may control the overall operation of the electronic device 2000. In an embodiment of the disclosure, the processor 2600 may include a plurality of processors. In an embodiment of the disclosure, at least one processor 2600 may execute one or more instructions of a program stored in the memory 2100 to perform the operations and functions of the electronic device 2000 disclosed in the present specification.

The processor 2600 may include, for example, at least one of central processing units (CPUs), microprocessors, graphics processing units (GPUs), application specific integrated circuits (ASICs), digital signal processors (DSPs), digital signal processing devices (DSPDs), programmable logic devices (PLDs), field programmable gate arrays (FPGAs), application processors (APs), neural processing units, or dedicated artificial intelligence processors designed with a hardware structure specialized for processing an artificial intelligence model, but the disclosure is not limited thereto.

When the method according to an embodiment of the disclosure includes a plurality of operations, the operations may be performed by one processor or a plurality of processors. For example, when a first operation, a second operation, and a third operation are performed by the method according to an embodiment of the disclosure, the first operation, the second operation, and the third operation may all be performed by a first processor. Alternatively, the first operation and the second operation may be performed by the first processor and the third operation may be performed by a second processor. However, an embodiment of the disclosure is not limited thereto.

The at least one processor according to the disclosure may be implemented as a single-core processor or may be implemented as a multi-core processor. When the method according to an embodiment of the disclosure includes a plurality of operations, the operations may be performed by one core or may be performed by a plurality of cores included in the at least one processor.

In an embodiment of the disclosure, at least one processor (2600) may be configured to execute one or more instructions to obtain a probability value of at least one pixel of an input image, based on weight value data pre-stored in memory. In an embodiment of the disclosure, the probability value of the at least one pixel may include a probability value for each of a plurality of colors of a color palette of a display.

In an embodiment of the disclosure, the at least one processor (2600) may be further configured to execute one or more instructions to obtain a dithered image corresponding to the input image by performing sampling based on the probability value of the at least one pixel and uniform distribution noise.

In an embodiment of the disclosure, the pre-stored weight value data may include weight values optimized to express a plurality of preset colors by performing a weighted sum operation on the plurality of colors of the color palette.

In an embodiment of the disclosure, the at least one processor (2600) may be further configured to execute one or more instructions to obtain the weight values optimized to express colors of a plurality of pixels of the input image by performing the weighted sum operation on the plurality of colors of the color palette, based on the pre-stored weight value data. In an embodiment of the disclosure, the at least one processor (2600) may be further configured to execute one or more instructions to obtain a probability map of the input image including the obtained optimized weight values as probability values of the plurality of pixels. In an embodiment of the disclosure, the probability map may include a plurality of channels respectively corresponding to the plurality of colors of the color palette.

In an embodiment of the disclosure, the at least one processor (2600) may be further configured to execute one or more instructions to identify a plurality of colors closest to a color of a first pixel of the input image among the plurality of preset colors. In an embodiment of the disclosure, the at least one processor (2600) may be further configured to execute one or more instructions to interpolate weight values optimized to express the color of the first pixel, based on the weight values optimized to express the plurality of identified colors.

In an embodiment of the disclosure, the at least one processor may be further configured to execute the one or more instructions to perform preprocessing, including at least one of gamma correction or color gamut compression, on the input image.

In an embodiment of the disclosure, the at least one processor (2600) may be further configured to execute the one or more instructions to perform at least one of first probability correction that adjusts a probability value less than or equal to a threshold value to zero with respect to the probability value of the at least one pixel or second probability correction that is temperature scaling for the probability value.

In an embodiment of the disclosure, the uniform distribution noise may include blue noise. In an embodiment of the disclosure, in the uniform distribution noise, a noise value corresponding to an object area of the input image may have a first frequency characteristic, and a noise value corresponding to a remaining area excluding the object area of the input image may have a second frequency characteristic. In an embodiment of the disclosure, the second frequency characteristic may have fewer high frequency components and more low frequency components in a frequency response than the first frequency characteristic.

In an embodiment of the disclosure, the at least one processor may be further configured to execute the one or more instructions to obtain a cumulative distribution function for the plurality of colors of the color palette of the at least one pixel, based on the probability value of the at least one pixel. In an embodiment of the disclosure, the at least one processor (2600) may be further configured to execute the one or more instructions to determine a color of at least one pixel of the dithered image corresponding to the at least one pixel as one of the plurality of colors of the color palette by performing inverse transform sampling based on the value of the uniform distribution noise and the cumulative distribution function.

In an embodiment of the disclosure, the cumulative distribution function may form a cumulative probability distribution in which the plurality of colors of the color palette are accumulated in descending order of correlation with brightness.

In an embodiment of the disclosure, the at least one processor (2600) may be further configured to execute the one or more instructions to calculate an error for the first pixel of the input image based on a difference between the color of the first pixel of the input image and a color of a first pixel of a dithered image corresponding to the first pixel of the input image determined through the sampling. In an embodiment of the disclosure, the at least one processor (2600) may be further configured to execute the one or more instructions to modify a color value of a second pixel of the input image, based on the error for the first pixel of the input image. In an embodiment of the disclosure, the at least one processor (2600) may be further configured to execute the one or more instructions to obtain weight values optimized to express a color corresponding to the modified color value, based on the pre-stored weight value data. In an embodiment of the disclosure, the at least one processor (2600) may be further configured to execute the one or more instructions to determine the obtained optimized weight values as a probability value of the second pixel of the input image.

On the other hand, the embodiment of the disclosure may be implemented in the form of a computer-readable recording medium including computer-executable instructions, such as program modules executable by a computer. A computer-readable recording medium may be any available media that are accessible by the computer and may include any volatile and non-volatile media and any removable and non-removable media. In addition, the computer-readable recording medium may include a computer storage medium and a communication medium. The computer storage medium may include any volatile, non-volatile, removable, and non-removable media that are implemented in any method or technology for storage of information, such as computer-readable instructions, data structures, program modules, or other data. The communication medium may typically include computer-readable instructions, data structures, or other data of a modulated data signal, such as program modules.

Also, the computer-readable recording medium may be provided in the form of a non-transitory computer-readable recording medium. The “non-transitory storage medium” is a tangible device and only means not including a signal (e.g., electromagnetic waves). This term does not distinguish between a case where data is semi-permanently stored in a storage medium and a case where data is temporarily stored in a storage medium. For example, the ‘non-transitory storage medium’ may include a buffer in which data is temporarily stored.

A method according to an embodiment of the disclosure may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

At least one of the components, elements, modules and units (collectively “components” in this paragraph) represented by a block in the drawings such as FIGS. 3-11 may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU), a microprocessor, or the like that performs the respective functions.

The foregoing description of the disclosure is for illustrative purposes only, and those of ordinary skill in the art to which the disclosure pertains will understand that modifications into other specific forms may be made thereto without changing the technical spirit or essential features of the disclosure. Therefore, it should be understood that the embodiments of the disclosure described above are illustrative in all aspects and are not restrictive. For example, the components described as being singular may be implemented in a distributed manner. Similarly, the components described as being distributed may be implemented in a combined form.

The scope of the disclosure is defined by the appended claims rather than the above detailed description, and all changes or modifications derived from the meaning and scope of the claims and equivalent concepts thereof should be construed as falling within the scope of the disclosure.

What is claimed is:

1. A method of dithering an image by an electronic device, the method comprising:
obtaining a probability value of at least one pixel of an input image, based on pre-stored weight value data, wherein the probability value of the at least one pixel comprises a probability value for each of a plurality of colors of a color palette of a display; and
obtaining a dithered image associated with the input image using sampling based on the probability value of the at least one pixel and uniform distribution noise,
wherein the pre-stored weight value data comprises first weight values optimized to represent a plurality of preset colors, and wherein the optimization is based on a weighted sum of the plurality of colors of the color palette.

2. The method of claim 1, wherein the obtaining of the probability value of the at least one pixel comprises:
obtaining second weight values optimized to represent colors of a plurality of pixels of the input image by performing the weighted sum of the plurality of colors of the color palette, based on the pre-stored weight value data; and
obtaining a probability map of the input image comprising the second weight values as probability values of the plurality of pixels,
wherein the probability map comprises a plurality of channels associated with the plurality of colors of the color palette.

3. The method of claim 2, wherein the obtaining of the second weight values optimized to represent the colors of the plurality of pixels of the input image comprises:
identifying a set of colors closest to a color of a first pixel of the input image among the plurality of preset colors; and
interpolating weight values optimized to represent the color of the first pixel, based on the first weight values associated with the set of colors.

4. The method of claim 1, further comprising preprocessing the input image, the preprocessing comprising performing at least one of gamma correction or color gamut compression on the input image.

5. The method of claim 1, further comprising:
performing at least one of first probability correction that adjusts a probability value less than or equal to a threshold value to zero with respect to the probability value of the at least one pixel or second probability correction that is temperature scaling for the probability value.

6. The method of claim 1, wherein the uniform distribution noise includes blue noise.

7. The method of claim 1, wherein, the uniform distribution noise comprises a first noise value corresponding to an object area of the input image has a first frequency characteristic, and a second noise value corresponding to a remaining area excluding the object area of the input image has a second frequency characteristic, and
wherein the second frequency characteristic has fewer high frequency components and more low frequency components in a frequency response than the first frequency characteristic.

8. The method of claim 1, wherein the obtaining of the dithered image comprises:
obtaining a cumulative distribution function for the plurality of colors of the color palette of the at least one pixel, based on the probability value of the at least one pixel; and
determining a color of at least one pixel of the dithered image corresponding to the at least one pixel as one of the plurality of colors of the color palette using inverse transform sampling based on a value of the uniform distribution noise and the cumulative distribution function.

9. The method of claim 8, wherein the cumulative distribution function forms a cumulative probability distribution in which the plurality of colors of the color palette are accumulated in descending order of correlation with brightness.

10. The method of claim 1, wherein the obtaining of the probability value of the at least one pixel comprises:
calculating an error associated with a first pixel of the input image based on a difference between a color of the first pixel of the input image and a color of a first pixel of the dithered image corresponding to the first pixel of the input image;
modifying a color value of a second pixel of the input image, based on the error;
obtaining third weight values optimized to represent a color associated with the modified color value, based on the pre-stored weight value data; and
determining the third weight values as a probability value of the second pixel of the input image.

11. An electronic device for dithering an image, the electronic device comprising:
a display;
memory storing one or more instructions; and
at least one processor configured to, individually or collectively, execute the one or more instructions stored in the memory to:
obtain a probability value of at least one pixel of an input image, based on weight value data pre-stored in the memory (2100), wherein the probability value of the at least one pixel comprises a probability value for each of a plurality of colors of a color palette of the display; and
obtain a dithered image associated with the input image using sampling based on the probability value of the at least one pixel and uniform distribution noise,
wherein the pre-stored weight value data comprises first weight values optimized to represent a plurality of preset colors, wherein the optimization is based on a weighted sum of the plurality of colors of the color palette.

12. The electronic device of claim 11, wherein the at least one processor is further configured to, individually or collectively, execute the one or more instructions to:
obtain second weight values optimized to represent colors of a plurality of pixels of the input image by performing the weighted sum of the plurality of colors of the color palette, based on the pre-stored weight value data; and
obtain a probability map of the input image comprises the second weight values as probability values of the plurality of pixels,
wherein the probability map comprises a plurality of channels associated with the plurality of colors of the color palette.

13. The electronic device of claim 12, wherein the at least one processor is further configured to, individually or collectively, execute the one or more instructions to:
identify a set of colors closest to a color of a first pixel of the input image among the plurality of preset colors; and
interpolate weight values optimized to represent the color of the first pixel, based on the first weight values associated with the set of colors.

14. The electronic device of claim 11, wherein the at least one processor is further configured to, individually or collectively, execute the one or more instructions to pre-process the input image, the pre-processing comprising at least one of gamma correction or color gamut compression on the input image.

15. The electronic device of any one of claims 11 to 14, wherein the at least one processor is further configured to execute the one or more instructions to perform at least one of first probability correction that adjusts a probability value less than or equal to a threshold value to zero with respect to the probability value of the at least one pixel or second probability correction that is temperature scaling for the probability value.

16. The electronic device of claim 11, wherein the uniform distribution noise comprises blue noise.

17. The electronic device of claim 11, wherein, the uniform distribution noise comprises a first noise value corresponding to an object area of the input image has a first frequency characteristic, and a second noise value corresponding to a remaining area excluding the object area of the input image has a second frequency characteristic, and
wherein the second frequency characteristic has fewer high frequency components and more low frequency components in a frequency response than the first frequency characteristic.

18. The electronic device of claim 11, wherein the at least one processor is further configured to, individually or collectively, execute the one or more instructions to:
obtain a cumulative distribution function for the plurality of colors of the color palette of the at least one pixel, based on the probability value of the at least one pixel; and
determine a color of at least one pixel of the dithered image corresponding to the at least one pixel as one of the plurality of colors of the color palette using inverse transform sampling based on the value of the uniform distribution noise and the cumulative distribution function.

19. The electronic device of claim 18, wherein the cumulative distribution function forms a cumulative probability distribution in which the plurality of colors of the color palette are accumulated in descending order of correlation with brightness.

20. A non-transitory computer-readable medium storing one or more instructions, that when executed by one or more processors, causes the one or more processors to:
obtain a probability value of at least one pixel of an input image, based on weight value data pre-stored in the memory (2100), wherein the probability value of the at least one pixel comprises a probability value for each of a plurality of colors of a color palette of the display; and
obtain a dithered image associated with the input image using sampling based on the probability value of the at least one pixel and uniform distribution noise,
wherein the pre-stored weight value data comprises first weight values optimized to represent a plurality of preset colors, wherein the optimization is based on a weighted sum of the plurality of colors of the color palette.
